SEQUENCE LISTING (113 sequences)

SEQ ID NO: 1 - DNA, 18 bp, Artificial
  HA gene forward primer
atccacaaaatgaaggca

SEQ ID NO: 2 - DNA, 24 bp, Artificial
  NA gene forward primer
agcagaagcagagcatcttctcaa

SEQ ID NO: 3 - DNA, 22 bp, Artificial
  HA/NA gene reverse primer
actagtaacaagagcatttttc

SEQ ID NO: 4 - DNA, 19 bp, Artificial
  M gene forward primer
agcagaagcacgcactttc

SEQ ID NO: 5 - DNA, 18 bp, Artificial
  M gene reverse primer
aaacaacgcactttttcc

SEQ ID NO: 6 - DNA, 25 bp, Artificial
  HA-1 capture sequence
accagacctgcttagacaggatagc

SEQ ID NO: 7 - DNA, 25 bp, Artificial
  HA-1 label sequence
gctggcacctttaatgcaggagaat

SEQ ID NO: 8 - DNA, 25 bp, Artificial
  HA-2 capture sequence
aacgaaatactcgagctggatgaga

SEQ ID NO: 9 - DNA, 24 bp, Artificial
  HA-2 label sequence
agtggatgatctcagagctgacac

SEQ ID NO: 10 - DNA, 16 bp, Artificial
  HA-3 capture sequence
gttcacctcatctgct

SEQ ID NO: 11 - DNA, 16 bp, Artificial
  HA-3 label sequence
atggagtaaccacaca

SEQ ID NO: 12 - DNA, 25 bp, Artificial
  HA-4 capture sequence
tgatgatggattggataaccatact

SEQ ID NO: 13 - DNA, 25 bp, Artificial
  HA-4 label sequence
tactgctctactactcaactgctgc

SEQ ID NO: 14 - DNA, 16 bp, Artificial
  HA-5 capture sequence
cccaaatgaaaaacct

SEQ ID NO: 15 - DNA, 16 bp, Artificial
  HA-5 label sequence
tatggagactcaaatc

SEQ ID NO: 16 - DNA, 25 bp, Artificial
  HA-6 capture sequence
aggaacaattacctatcaaagaggt

SEQ ID NO: 17 - DNA, 25 bp, Artificial
  HA-6 label sequence
ttttattgcctcaaaaagtgtggtg

SEQ ID NO: 18 - DNA, 16 bp, Artificial
  HA-7 capture sequence
tcccaaaaaacgacaa

SEQ ID NO: 19 - DNA, 16 bp, Artificial
  HA-7 label sequence
aacaaaacagcaacaa

SEQ ID NO: 20 - DNA, 23 bp, Artificial
  HA-8 capture sequence
ggtggattaaacaaaagcaagcc

SEQ ID NO: 21 - DNA, 23 bp, Artificial
  HA-8 label sequence
tactacacaggggaacatgcaaa

SEQ ID NO: 22 - DNA, 18 bp, Artificial
  HA-9 capture sequence
tcttctcagaggatacga

SEQ ID NO: 23 - DNA, 17 bp, Artificial
  HA-9 label sequence
cgtatcaggttatcaaa

SEQ ID NO: 24 - DNA, 16 bp, Artificial
  HA-10 capture sequence
gcaaaagtttcaatac

SEQ ID NO: 25 - DNA, 16 bp, Artificial
  HA-10 label sequence
ccatgaagtaagacct

SEQ ID NO: 26 - DNA, 17 bp, Artificial
  HA-11 capture sequence
gccataggaaattgccc

SEQ ID NO: 27 - DNA, 17 bp, Artificial
  HA-11 label sequence
atatgggtgaaaacacc

SEQ ID NO: 28 - DNA, 17 bp, Artificial
  HA-12 capture sequence
taattggtgaagcagat

SEQ ID NO: 29 - DNA, 16 bp, Artificial
  HA-12 label sequence
gccttcatgaaaaata

SEQ ID NO: 30 - DNA, 25 bp, Artificial
  HA-13 capture sequence
taaagaaaatgctgggtccctctgc

SEQ ID NO: 31 - DNA, 25 bp, Artificial
  HA-13 label sequence
gtagacatagggaatggatgcttcg

SEQ ID NO: 32 - DNA, 91 bp, Influenza B virus
cgaaaccaaacacaagtgcaaccagacctgcttagacaggatagctgctggcacctttaatgcaggagaattttctcttcccacttttgat

SEQ ID NO: 33 - DNA, 79 bp, Influenza B virus
gtgccatggatgaactccataacgaaatactcgagctggatgagaaagtggatgatctcagagctgacacaataagctc

SEQ ID NO: 34 - DNA, 72 bp, Influenza B virus
ggagactcaaatcctcaaaagttcacctcatctgctaatggagtaaccacacattatgtttctcagattggc

SEQ ID NO: 35 - DNA, 91 bp, Influenza B virus
attactgctgcatctttaaatgatgatggattggataaccatactatactgctctactactcaactgctgcttctagtttggctgtaacat

SEQ ID NO: 36 - DNA, 69 bp, Influenza B virus
gttccattctgataacaaaacccaaatgaaaaacctctatggagactcaaatcctcaaaagttcacctc

SEQ ID NO: 37 - DNA, 91 bp, Influenza B virus
gtgcaaaaatctgggaaaacaggaacaattacctatcaaagaggtattttattgcctcaaaaagtgtggtgcgcaagtggcaggagcaagg

SEQ ID NO: 38 - DNA, 73 bp, Influenza B virus
cgcaacaatggcttgggccgtcccaaaaaacgacaacaacaaaacagcaacaaattcattaacaatagaagta

SEQ ID NO: 39 - DNA, 87 bp, Influenza B virus
attgcctccacgaaaaatacggtggattaaacaaaagcaagccttactacacaggggaacatgcaaaggccataggaaattgcccaa

SEQ ID NO: 40 - DNA, 76 bp, Influenza B virus
aaaattagacagctgcccaatcttctcagaggatacgaacgtatcaggttatcaaaccataacgttatcaatgcag

SEQ ID NO: 41 - DNA, 68 bp, Influenza B virus
gggaacataccttcggcaaaagtttcaatactccatgaagtaagacctgttacatctgggtgctttcc

SEQ ID NO: 42 - DNA, 67 bp, Influenza B virus
gaacatgcaaaagccataggaaattgcccaatatgggtgaaaacacctttgaagcttgccaatggaa

SEQ ID NO: 43 - DNA, 74 bp, Influenza B virus
aataaaagggtccttgcctttaattggtgaagcagattgccttcatgaaaaatacggtggattaaacaaaagca

SEQ ID NO: 44 - DNA, 91 bp, Influenza B virus
attggcacttgagagaaaactaaagaaaatgctgggtccctctgctgtagacatagggaatggatgcttcgaaaccaaacacaagtgcaac

SEQ ID NO: 45 - DNA, 16 bp, Artificial
  NA-1 capture sequence
aatatggagaagcata

SEQ ID NO: 46 - DNA, 16 bp, Artificial
  NA-1 label sequence
actgacacataccatt

SEQ ID NO: 47 - DNA, 24 bp, Artificial
  NA-2 capture sequence
gattgatgtgcacagagacttatt

SEQ ID NO: 48 - DNA, 23 bp, Artificial
  NA-2 label sequence
ggacacccccagaccaaatgatg

SEQ ID NO: 49 - DNA, 16 bp, Artificial
  NA-3 capture sequence
actgtcatacttacta

SEQ ID NO: 50 - DNA, 16 bp, Artificial
  NA-3 label sequence
attcggatatattgct

SEQ ID NO: 51 - DNA, 16 bp, Artificial
  NA-4 capture sequence
gagacagaaacaagct

SEQ ID NO: 52 - DNA, 16 bp, Artificial
  NA-4 capture sequence
aggcatctaatttcag

SEQ ID NO: 53 - DNA, 18 bp, Artificial
  NA-5 capture sequence
gaatggacatatatcgga

SEQ ID NO: 54 - DNA, 17 bp, Artificial
  NA-5 label sequence
ttgatggccctgacaat

SEQ ID NO: 55 - DNA, 16 bp, Artificial
  NA-6 capture sequence
attcggatatattgct

SEQ ID NO: 56 - DNA, 16 bp, Artificial
  NA-6 label sequence
aaattttcaccaacag

SEQ ID NO: 57 - DNA, 17 bp, Artificial
  NA-7 capture sequence
cctggttggtattcttt

SEQ ID NO: 58 - DNA, 16 bp, Artificial
  NA-7 label sequence
ggtttcgaaataaaag

SEQ ID NO: 59 - DNA, 20 bp, Artificial
  NA-8 capture sequence
aggcaaaatcccaactgtag

SEQ ID NO: 60 - DNA, 19 bp, Artificial
  NA-8 label sequence
aaactccattttccacatg

SEQ ID NO: 61 - DNA, 16 bp, Artificial
  NA-9 capture sequence
tggaagatggtactcc

SEQ ID NO: 62 - DNA, 16 bp, Artificial
  NA-9 label sequence
gaacgatgtctaaaac

SEQ ID NO: 63 - DNA, 21 bp, Artificial
  NA-10 capture sequence
caggctgtgaaccgttctgca

SEQ ID NO: 64 - DNA, 20 bp, Artificial
  NA-10 label sequence
caaaaggggtgacacttctt

SEQ ID NO: 65 - DNA, 17 bp, Artificial
  NA-11 capture sequence
acttggcactcagcagc

SEQ ID NO: 66 - DNA, 17 bp, Artificial
  NA-11 label sequence
acagccatttactgttt

SEQ ID NO: 67 - DNA, 19 bp, Artificial
  NA-12 capture sequence
tgatggctcagcttcaggg

SEQ ID NO: 68 - DNA, 19 bp, Artificial
  NA-12 label sequence
ttagtgaatgcagatttct

SEQ ID NO: 69 - DNA, 18 bp, Artificial
  NA-13 capture sequence
ataattgcaccaacaacg

SEQ ID NO: 70 - DNA, 17 bp, Artificial
  NA-13 label sequence
cgttggactccgcgaac

SEQ ID NO: 71 - DNA, 23 bp, Artificial
  NA-14 capture sequence
cataacagggccttgcgaatcta

SEQ ID NO: 72 - DNA, 22 bp, Artificial
  NA-14 label sequence
tggggacaaagggcgtggaggc

SEQ ID NO: 73 - DNA, 65 bp, Influenza B virus
tgctcaaaataaaatatggagaagcatatactgacacataccattcctatgcaaacaacatccta

SEQ ID NO: 74 - DNA, 88 bp, Influenza B virus
gactgatacagcggaaataagattgatgtgcacagagacttatttggacacccccagaccaaatgatggaagcataacagggccttgc

SEQ ID NO: 75 - DNA, 64 bp, Influenza B virus
tcactatatgtgtcagcttcactgtcatacttactatattcggatatattgctaaaattttcac

SEQ ID NO: 76 - DNA, 73 bp, Influenza B virus
atactacaatggaacaagaggagacagaaacaagctgaggcatctaatttcagtcaaattgggcaaaatccca

SEQ ID NO: 77 - DNA, 76 bp, Influenza B virus
ccgcatgccatgatggtaaggaatggacatatatcggagttgatggccctgacaataatgcattgctcaaaataaa

SEQ ID NO: 78 - DNA, 70 bp, Influenza B virus
actgtcatacttactatattcggatatattgctaaaattttcaccaacagaaataactgcaccaacaatg

SEQ ID NO: 79 - DNA, 57 bp, Influenza B virus
gaacctggttggtattctttcggtttcgaaataaaagataagaaatgcgatgtcccc

SEQ ID NO: 80 - DNA, 66 bp, Influenza B virus
caacttaggcaaaatcccaactgtagaaaactccattttccacatggcagcttggagtggatccgc

SEQ ID NO: 81 - DNA, 73 bp, Influenza B virus
caaagaatggcatccaagattggaagatggtactcccgaacgatgtctaaaactgaaagaatggggatggaac

SEQ ID NO: 82 - DNA, 82 bp, Influenza B virus
gtgcaaacgcatcaaatgttcaggctgtgaaccgttctgcaacaaaaggggtgacacttcttctcccagaaccggagtggac

SEQ ID NO: 83 - DNA, 51 bp, Influenza B virus
acttggcactcagcagcaacagccatttactgtttaatgggctcaggacaa

SEQ ID NO: 84 - DNA, 79 bp, Influenza B virus
gattgttatcttatgataactgatggctcagcttcagggattagtgaatgcagatttcttaagattcgagagggccgaa

SEQ ID NO: 85 - DNA, 76 bp, Influenza B virus
taaaattttcaccaacaaaaataattgcaccaacaacgtcgttggactccgcgaacgcatcaaattttcaggccgt

SEQ ID NO: 86 - DNA, 86 bp, Influenza B virus
cccagaccagatgatggaagcataacagggccttgcgaatctaatggggacaaagggcgtggaggcatcaagggaggatttgttca

SEQ ID NO: 87 - DNA, 19 bp, Artificial
  M-1 capture sequence
catgaagcatttgaaatag

SEQ ID NO: 88 - DNA, 18 bp, Artificial
  M-1 label sequence
agaaggccatgaaagctc

SEQ ID NO: 89 - DNA, 19 bp, Artificial
  M-2 capture sequence
atggagatattgagtgacc

SEQ ID NO: 90 - DNA, 18 bp, Artificial
  M-2 label sequence
catagtgattgaggggct

SEQ ID NO: 91 - DNA, 20 bp, Artificial
  M-3 capture sequence
aatacgaataaaaggtccaa

SEQ ID NO: 92 - DNA, 20 bp, Artificial
  M-3 label sequence
taaagagacaataaacagag

SEQ ID NO: 93 - DNA, 16 bp, Artificial
  M-4 capture sequence
gtgaaacagttttgga

SEQ ID NO: 94 - DNA, 16 bp, Artificial
  M-4 label sequence
gtagaagaattgcatt

SEQ ID NO: 95 - DNA, 19 bp, Artificial
  M-5 capture sequence
tttttaaaacccaaagacc

SEQ ID NO: 96 - DNA, 19 bp, Artificial
  M-5 label sequence
ggaaaggaaaagaagattc

SEQ ID NO: 97 - DNA, 25 bp, Artificial
  M-6 capture sequence
gagacacagttaccaaaaagaaatc

SEQ ID NO: 98 - DNA, 25 bp, Artificial
  M-6 label sequence
aggccaaagaaacaatgaaggaggt

SEQ ID NO: 99 - DNA, 24 bp, Artificial
  M-7 capture sequence
tgaacacagcaaaaacaatgaatg

SEQ ID NO: 100 - DNA, 23 bp, Artificial
  M-7 label sequence
aatggggaagggagaagacgtcc

SEQ ID NO: 101 - DNA, 23 bp, Artificial
  M-8 capture sequence
caacattggagtgctgagatctc

SEQ ID NO: 102 - DNA, 23 bp, Artificial
  M-8 label sequence
tggggcaagtcaaaagaatgggg

SEQ ID NO: 103 - DNA, 21 bp, Artificial
  M-9 capture sequence
actgttggttcggtgggaaag

SEQ ID NO: 104 - DNA, 21 bp, Artificial
  M-9 label sequence
atttgacctagactctgcctt

SEQ ID NO: 105 - DNA, 51 bp, Influenza B virus
agctttcatgaagcatttgaaatagcagaaggccatgaaagctcagcgcta

SEQ ID NO: 106 - DNA, 71 bp, Influenza B virus
actatctaacaacatggagatattgagtgaccacatagtgattgaggggctttctgctgaagagataataa

SEQ ID NO: 107 - DNA, 81 bp, Influenza B virus
aaaagaggagtaaacatgaaaatacgaataaaaggtccaaataaagagacaataaacagagaggtatcaattttgagacac

SEQ ID NO: 108 - DNA, 53 bp, Influenza B virus
tgaagagataataaaaatgggtgaaacagttttggaggtagaagaattgcatt

SEQ ID NO: 109 - DNA, 79 bp, Influenza B virus
taattggtgcctctatatgctttttaaaacccaaagaccaggaaaggaaaagaagattcatcacagagcctctatcagg

SEQ ID NO: 110 - DNA, 91 bp, Influenza B virus
aacagagaggtatcaattttgagacacagttaccaaaaagaaatccaggccaaagaaacaatgaaggaggtactctctgacaacatggagg

SEQ ID NO: 111 - DNA, 88 bp, Influenza B virus
aatgcagatggtttcagctatgaacacagcaaaaacaatgaatggaatggggaagggagaagacgtccaaaaactggcagaagagctg

SEQ ID NO: 112 - DNA, 87 bp, Influenza B virus
ctggcagaagagctgcaaagcaacattggagtgctgagatctcttggggcaagtcaaaagaatggggaaggaattgcaaaggatgta

SEQ ID NO: 113 - DNA, 83 bp, Influenza B virus
agaactagcagaaaaattacactgttggttcggtgggaaagaatttgacctagactctgccttggaatggataaaaaacaaaa

(19) United States
(12) Patent Application Publication
(10) Pub. No.: US 2010/0130378 A1
(43) Pub. Date: May 27, 2010

(54) MICROARRAY-BASED LINEAGE ANALYSIS AS A DIAGNOSTIC FOR CURRENT AND EMERGING STRAINS OF INFLUENZA B

(76) Inventors: Kathy L. Rowlen, Boulder, CO (US); Daniela M. Mehlmann, Birsfelden (CH); Robert Kuchta, Boulder, CO (US); Martin Mehlmann, Birsfelden (CH); James Smagala, Arvada, CO (US); Chad Moore, San Diego, CA (US); Erica Dawson-Tenet, Broomfield, CO (US); Nancy Cox, Atlanta, GA (US); Michael W. Shaw, Decatur, GA (US)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(21) Appl. No.: 12/522,146

(22) PCT Filed: Jan. 3, 2008
(86) PCT No.: PCT/US08/50112

§ 371 Date: Feb. 9, 2010

Related U.S. Application Data
(60) Provisional application No. 60/883,499, filed on Jan. 4, 2007.

(51) Int. Cl. C40B 30/04; C40B 40/06; C40B 50/14

(52) U.S. Cl. 506/9; 506/16; 506/30

(57) ABSTRACT

Embodiments herein provide for methods, compositions and apparatus for detection and/or diagnosis of pathogenic virus lineage and/or strains. In some embodiments, the virus is influenza Type B virus. In other embodiments, an apparatus may include a microarray with attached capture probes, designed to bind to nucleic acid sequences from a single gene in a broad array of influenza strains. In some embodiments, compositions may include isolated nucleic acid sequences of use as capture probes, target sequences and/or label probe sequences, for diagnosis of and/or detection of influenza virus.

### RELATED APPLICATIONS

This application claims the benefit under 35 U.S.C. §119(e) of U.S. provisional patent application Ser. No. 60/883,499 filed on Jan. 04, 2007, incorporated herein by reference in their entirety.

### FIELD

Embodiments herein relate to compositions, systems, methods and apparati for detection and/or differential diagnosis of influenza B. In some embodiments, influenza B strains, such as a B/Victoria/2/87 (Vic87) strain, a Vic87-like strain, a B/Yamagata/16/88 (Yam88) strain or a Yam88-like strain may be distinguished from one another.

### BACKGROUND

Influenza is an orthomyxovirus with three genera, types A, B, and C. The types are distinguished by the nucleoprotein antigenicity. Types A and B are the most clinically significant, causing mild to severe respiratory illness. Influenza B is a human virus and does not appear to be present in an animal reservoir. Type A viruses exist in both human and animal populations, with significant avian and swine reservoirs. Influenza A and B each contain 8 segments of negative sense ssRNA. Type A viruses can also be divided into antigenic sub-types on the basis of two viral surface glycoproteins, hemagglutinin (HA) and neuraminidase (NA). There are currently 15 identified HA sub-types (designated H1 through H15) and 9 NA sub-types (N1 through N9) all of which can be found in wild aquatic birds. Of the 135 possible combinations of HA and NA, only four (H1N1, H1N2, H2N2, and H3N2) have widely circulated in the human population since the virus was first isolated in 1933. The two most common sub-types of influenza A currently circulating in the human population are H3N2 and H1N1.

Of influenza A, B, and C, distinguished by serological responses to their internal proteins, only types A and B have significant potential to cause severe disease and recurrent annual epidemics in humans. Although the influenza B virus is often associated with limited outbreaks of relatively mild disease, it has the potential to cause severe epidemics of considerable morbidity and mortality. In the last decade, B viruses have tended to be prominent and sometimes even dominant every 2-3 years.

Influenza B is almost entirely restricted to humans, while the natural hosts for influenza A viruses are aquatic birds, with various mammals including humans also being infected. Since influenza B also does not show the large variety of antigenically distinct subtypes as found with influenza A, no antigenic shift has been observed in influenza B viruses. Like influenza A, influenza B viruses are subject to antigenic drift through the accumulation of point mutations, with a slightly lower evolutionary rate than type A. Since the early 1980's, two distinct evolutionary lineages of influenza B have co-circulated in humans. These lineages are antigenically related to the prototype strains, B/Victoria/2/87 (Vic87) and B/Yamagata/16/88 (Yam88). With the continued evolution of co-circulating strains and multiple genotypes of influenza B, the issues associated with viral reassortment have become a much greater concern.

During the 1990s, Vic87-like viruses were isolated infrequently and were limited almost entirely to eastern Asia until they reappeared in North America and Europe in 2001. Although not considered subtypes, Yam88-like and Vic87-like viruses are antigenically different, producing little or no post-infection cross-neutralizing antibody response in one mammal tested. In immunologically unprimed children, vaccination with a Yam88-like strain did not induce detectable hemagglutination inhibiting or neutralizing antibody to Vic87-like viruses. This lack of antigenic cross-reactivity has made the designation of a type B vaccine strain problematic, since current influenza vaccines are formulated to include only a single strain of influenza B.

Current public and scientific concern over the possible emergence of a pandemic strain of influenza or other pathogenic or non-pathogenic viruses requires a method for the rapid detection and typing of these viruses. A need exists for improved genetic diagnosis particularly for influenza B strain distinction to control and monitor the virus' impact on human, avian and animal health within the U.S. and worldwide.

### SUMMARY

Embodiments herein provide for methods, compositions and apparati for rapidly detecting and/or diagnosing the presence of a virus. In particular embodiments, the detection and/or diagnosis may extend to identifying the strain of an influenza virus present in a sample. Samples may include any type of sample from a subject suspected of having or been exposed to influenza B virus, including but not limited to, nasopharangeal washes, expectorate, respiratory tract swabs, throat swabs, tracheal aspirates, bronchoalveolar lavage, mucus and saliva. Subjects contemplated herein include, but not limited to, humans, birds, cats, horses, dogs, rodents, swine, and other domesticated and wild animals.

Some embodiments of the present invention concern an array that includes a plurality of capture probes bound to the surface of a solid substrate or suspended in a solution. In accordance with these embodiments, the capture probes are capable of binding to nucleic acid sequences comprising at least a portion of a nucleic acid sequence or complimentary nucleic acid sequence of a target gene of one or more strains of influenza type B (e.g. BChip). In addition, the array can further include positive and/or negative controls bound to the surface of the solid substrate or in a parallel sample. In some embodiments, the array may be a microarray or a multi-channel microarray.

In certain embodiments, oligonucleotides can include, but are not limited to, at least a portion of a nucleic acid sequence or complimentary nucleic acid sequence of a target gene of one or more influenza B strains. In accordance with these embodiments the influenza B strain can include, but is not limited to, B/Victoria/2/87 (Vic87) strain, B/Victoria/2/87-like strain, B/Yamagata/16/88 (Yam88) strain, B/Yamagata/16/88-like strain and a combination thereof. Some embodiments herein concern arrays capable of detecting B/Victoria/2/87 (Vic87) strains, and B/Victoria/2/87-like strains. In accordance with these embodiments, arrays capable of detecting B/Victoria/2/87 (Vic87) strains and B/Victoria/2/87-like strains can distinguish these strains from B/Yamagata/16/88 (Yam88) strains and B/Yamagata/16/88-like strains. Other embodiments herein concern arrays capable of detecting B/Yamagata/16/88 (Yam88) strains and B/Yamagata/16/88-like strains. In accordance with these embodiments, arrays capable of detecting B/Yamagata/16/88 (Yam88) strains and B/Yamagata/16/88-like strains can distinguish these strains from B/Victoria/2/87 (Vic87) strains and B/Victoria/2/87-like strains. In addition, arrays can include capture probes selected from sequences listed in Table 2, Table 3, Table 4 or a combination thereof. Capture and label probes indicated herein can be interchangeable, thus either the sequences listed as capture, label or combination thereof can be used to create an array. In certain embodiments, arrays contain 100 or less capture probes (and/or label sequences) bound to the surface of the solid substrate.

In some embodiments, an array can be bound to a solid substrate. In accordance with these embodiments, a solid surface can include, but is not limited to, glass, plastic, silicon-coated substrate, macromolecule-coated substrate, particles, beads, microparticles, microbeads, dipstick, magnetic beads, microtiter wells, paramagnetic beads and a combination thereof. In some particular embodiments, the capture probes are about 10 to about 50 nucleotides (nt) in length or about 15 to about 35 nts, or about 15 to 30 nts in length. In other embodiments, the capture probes can be a mixture of various length probes for example, 10 nts to 100 nts. In yet other embodiments, the capture probes can be about the same nt length for example 20 nts in length, 30 nts in length or 40 nts in length.

Some embodiments concern a method for attaching a plurality of capture probes to a solid substrate surface to form an array, wherein the capture probes are capable of binding to nucleic acid sequences comprising at least a portion of a nucleic acid sequence or complimentary nucleic acid sequence of a target gene of one or more strains of influenza type B. In addition, the method may further include attaching one or more positive and/or negative control oligonucleotides to the solid substrate surface. The oligonucleotides contemplated herein can include at least a portion of a nucleic acid sequence or complimentary nucleic acid sequence of a target gene selected from the group consisting of hemagglutinin (HA gene segment), neuraminidase (NA gene segment), matrix protein (M gene segment) and a combination thereof. In one embodiment, oligonucleotides can include at least a portion of a nucleic acid sequence of the HA gene. In another embodiment, an oligonucleotide can include at least a portion of a nucleic acid sequence or complimentary nucleic acid sequence of a target gene of one or more influenza B strains. These strains can include, but are not limited to, B/Victoria/2/87 (Vic87) strain, B/Victoria/2/87-like strain, B/Yamagata/16/88 (Yam88) strain, B/Yamagata/16/88-like strain and a combination thereof.

Other exemplary methods herein concern detecting influenza type B strain in a sample, the method includes: a) contacting an array to form an array-sample complex when the sample contains nucleic acid sequences comprising at least a portion of a nucleic acid sequence or complimentary nucleic acid sequence of one or more strains of influenza type B, wherein the array comprises a plurality of capture probes comprising at least a portion of a nucleic acid sequence or complimentary nucleic acid sequence of a target gene of one or more strains of influenza type B; b) contacting the array of step (a) with one or more probes to form a target-probe complex when the array of step (a) comprises the array-sample complex, wherein the probes are capable of being detected; and c) determining the presence of the target-probe complex, wherein the presence of the target-probe complex is indicative of the presence of an influenza type B strain. In accordance with these methods, the probe can include one or more tagged label probes and wherein the tagged label probes are capable of producing a signal. In other embodiments, the array can be contacted with one or more positive and/or negative controls, for example, to determine the reliability of the array to detect a target sequence. In one example, influenza B strain can be selected from the group consisting of B/Victoria/2/87 (Vic87) strain, B/Victoria/2/87-like strain, B/Yamagata/16/88 (Yam88) strain, B/Yamagata/16/88-like strain and a combination thereof. New emerging strains are contemplated herein. These emerging strains can be a B/Victoria/2/87-like strain or a B/Yamagata/16/88-like strain. These emerging strains are contemplated to be distinguishable by methods, compositions and apparati disclosed herein. In accordance with these examples, target gene(s) is/are selected from the group including hemagglutinin (HA gene segment), neuraminidase (NA gene segment), matrix protein (M gene segment) and a combination thereof. In one particular embodiment, the array in step c) can produce a different signal depending on the influenza type B strain.

Samples herein can be obtained from a subject and/or an object. Certain examples can include, but are not limited to, sample(s) from an object such as air samples, air-filter samples, surface-associated samples and a combination thereof. Example air samples can be derived from, for example, a hospital, a temporary or permanent residence, a place of business, a place of education, a daycare, adult care facility, an airplane, a vehicle, a boat or combination thereof

In some embodiments, influenza type B strain or strains can be identified in about 36 hours or less; 24 hours or less; 12 hours or less; or 8 hours or less.

Another embodiment herein can concern probes including oligonucleotides of at least a portion of a nucleic acid sequence of a target gene of one or more strains of influenza type B, wherein the probes are capable of binding to at least a portion of a nucleic acid sequence or complimentary nucleic acid sequence of a target gene of one or more strains of influenza type B.

Other embodiments include kits for practicing the embodiments disclosed herein. One exemplary kit includes: a) an array of a plurality of capture probes bound to the surface of a solid substrate, wherein the capture probes are capable of binding to nucleic acid sequences including at least a portion of a nucleic acid sequence or complimentary nucleic acid sequence of a target gene of one or more strains of influenza type B; and b) one or more tagged label probes wherein the tagged label probe is capable of producing a signal. In some kits, an array can include positive and/or negative controls.

The skilled artisan will realize that although the methods, compositions and apparatus are described in terms of the particular embodiments for application of identifying particular influenza B virus strains, they are also of use with other types of viral strain detection and/or diagnosis.

### BRIEF DESCRIPTION OF THE DRAWINGS

The following drawings form part of the present specification and are included to further demonstrate certain embodiments of the present invention. The embodiments may be better understood by reference to one or more of these drawings in combination with the detailed description of specific embodiments presented herein.

FIG. 1 represents an exemplary schematic for generating an array herein.

FIG. 2 represents an exemplary array for identifying an influenza B strain or lineage.

FIG. 3 represents exemplary arrays for identifying influenza B virus.

FIG. 4 represents an exemplary schematic displaying the results of an influenza B lineage identification experiment.

FIG. 5 represents an exemplary histogram displaying influenza B lineage and the years the particular lineage appeared.

### DEFINITIONS

As used herein, “a” or “an” may mean one or more than one of an item.

A “sequence variant” is any variation in a nucleic acid sequence, such as the variations observed in a given gene sequence between different strains, types or subtypes of influenza virus. Sequence variants may include, but are not limited to, insertions, deletions, substitutions, mutations and single nucleotide polymorphisms.

A “capture” probe or sequence is an oligonucleotide that is capable of forming a complex with a nucleic acid sequence including at least a portion of a nucleic acid sequence or complimentary nucleic acid sequence of a target gene. Forming a complex can include hybridizing to, binding to or associating with nucleic acid sequences including at least a portion of a nucleic acid sequence or complimentary nucleic acid sequence of a target gene. Note: capture and label sequences in some embodiments can be interchangeable.

A “label” probe or sequence is a nucleic acid sequence that is capable of forming a complex with nucleic acid sequences including at least a portion of a nucleic acid sequence or complimentary nucleic acid sequence of a target gene. Forming a complex can include hybridizing to, binding to or associating with nucleic acid sequences including at least a portion of a nucleic acid sequence or complimentary nucleic acid sequence of a target gene. In addition, a “label” probe is capable of producing a signal. In certain embodiments, a “label” probe or sequence may be detectably labeled, for example by attachment of a fluorescent, phosphorescent, chemiluminescent, chemoreactive, enzymatic, radioactive or other tag moiety. Alternatively, a label probe or sequence may contain one or more functional groups designed to bind to a detectable tag moiety. Note: capture and label sequences in some embodiments can be interchangeable.

“Vic87-like” as used herein can refer to any influenza virus that is determined to be antigenically related (e.g., antibody response as measured by, for example, using a hemagglutination inhibition assay) to a virus designated as B/Victoria/2/87 (Vic87).

“Yam88-like” as used herein can refer to any influenza virus that is determined to be antigenically related (e.g., antibody response as measured by, for example, using a hemagglutination inhibition assay) to a virus designated as B/Yamagata/16/88 (Yam88).

### DETAILED DESCRIPTION

In the following sections, various exemplary compositions and methods are described in order to detail various embodiments. It will be obvious to one skilled in the art that practicing the various embodiments does not require the employment of all or even some of the specific details outlined herein, but rather that sequences chosen, samples, concentrations, times and other specific details may be modified through routine experimentation. In some cases, well known methods or components have not been included in the description.

Embodiments herein provide for apparati and methods for distinguishing different strains and/or lineages of influenza B in a sample. In accordance with these embodiments, a sample can be obtained from a subject or an object and the sample can be analyzed for the presence or absence of an influenza B strain. In certain embodiments, methods concern exposing a sample to an array where the array can include a plurality of capture probes bound to the surface of a solid substrate and the capture probes are capable of binding to nucleic acid sequences comprising at least a portion of a nucleic acid sequence or complimentary nucleic acid sequence of a target gene of one or more strains of influenza type B.

### History of Influenza B Lineages

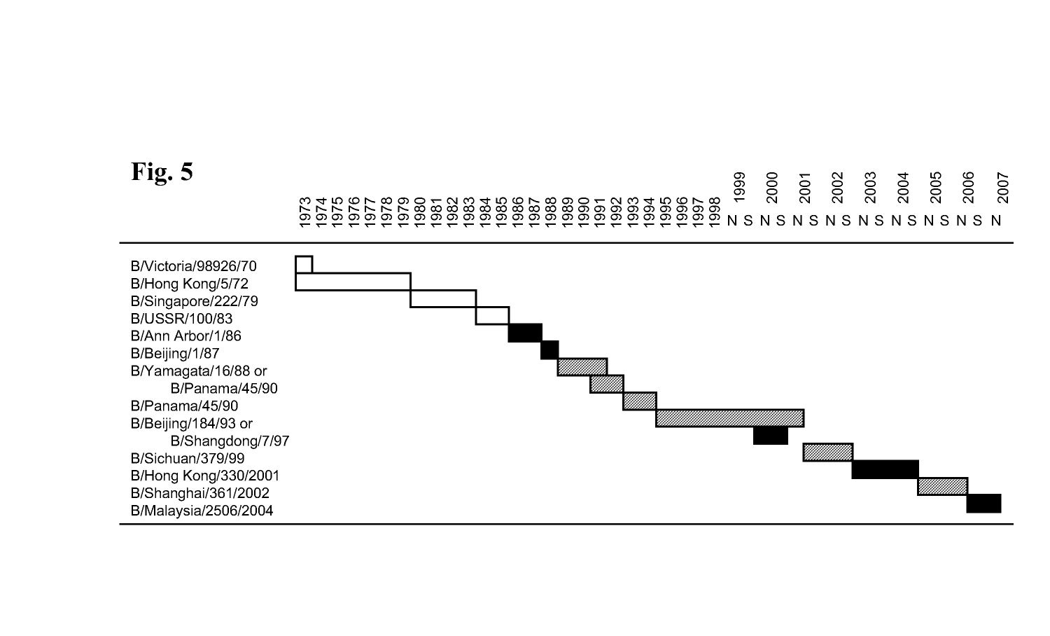

After a lineage split occurred in the early 1980′s, influenza B vaccine strains have changed with increasing frequency between Yam88-like and Vic87-like viruses (see FIG. 5). Continued surveillance of influenza type B viruses is critical in order to ensure that future treatments (e.g. vaccines) contain the most appropriate strain of virus.

A number of diagnostic methods are available for the detection of influenza viruses. Virus culture has been considered the “gold standard,” but is highly time-consuming (7-14 days) and has a low sample throughput even in light of recent rapid culture methods. Although a number of point-of-care rapid diagnostic tests are also available, many do not even detect influenza B. Other available methods are based either on amplification of viral nucleic acid (RNA) utilizing real-time reverse-transcription polymerase chain reaction (RRT-PCR), or on serological diagnosis, such as hemagglutination inhibition (HI), enzyme immunoassays, complement fixation, and neutralization tests. However, fewer tests are available for lineage determination of influenza viruses, the two most common methods being HI assay (antigenic characterization) and sequencing (phylogenetic characterization) after culture, both of which are time-consuming.

### Microarrays

A number of microarray-based methods for influenza detection have been reported, most of which can detect influenza B virus but do not provide lineage information.

A method for the detection of influenza types A and B and determination of HI, H3, H5 and N1, N2 subtypes of influenza A using a diagnostic microarray was recently developed (U.S. provisional patent applications Ser. No. 60/759,670 filed on Jan. 18, 2006 and Ser. No. 60/784,751 filed on Mar. 21, 2006, and PCT application PCT/US2007/060706 filed Jan. 18, 2007, incorporated herein by reference in their entirety). Embodiments herein concern the development of methods, apparati and compositions to distinguish between different lineages of influenza B virus. In one embodiment, a microarray (BChip) that specifically targets influenza B gene segments is contemplated. In one particular embodiment, influenza B gene segments can include HA, NA, M or a combination thereof. In accordance with these embodiments, these gene segments can provide lineage information of circulating lineages, for example, Yam88 and Vic87. In one particular embodiment, methods concern generating microarrays. In certain embodiments, a microarray can also include control samples such as negative control samples of influenza A and parainfluenza 1 or positive controls.

Methods, apparati, and compositions have previously been disclosed for the detection of influenza types A and B and determination of subtypes of influenza A, using a diagnostic microarray based on multiple genes (U.S. Patent Application No. 60/759,670, filed on Jan. 18, 2006, incorporated herein in its entirety). Diagnostic microarrays based on sequences of a single gene for distinguishing one type or subtype of influenza A from another (U.S. Patent Application No. 60/784,751, filed on Mar. 21, 2006, incorporated herein in its entirety) have also been described.

Certain embodiments concern compositions, systems, apparati and methods used for identifying influenza B and/or distinguishing one influenza B strain or lineage from another. In one embodiment, an array can be designed to include capture sequences capable of binding to nucleic acid sequences of at least a portion of a nucleic acid sequence or complimentary sequence of a target gene of one or more influenza B strains. In one particular embodiment, a microarray (e.g. BChip) containing sequences that are capable of binding nucleic acid sequences comprising at least a portion of a nucleic acid sequence or complimentary nucleic acid sequence of a target gene of one or more strains of influenza type B are contemplated.

Certain embodiments concern identifying target genes of influenza B strains and sequences of these target genes of use in an array contemplated herein. In accordance with these particular embodiments, gene segments can include, but are not limited to, hemagglutinin (HA), neuraminidase (NA), and matrix protein (M protein). In one example, B/Victoria/2/87 (Vic87) strain, B/Victoria/2/87-like strain, B/Yamagata/16/88 (Yam88) strain, B/Yamagata/16/88-like strain can be distinguished from one another using methods of the present invention. For example, an array can be designed containing oligonucleotides that bind to at least a portion of a nucleic acid sequence or complimentary nucleic acid sequence of a target gene of one strain of influenza B, but not another thereby differentiating between the strains or lineages. Alternatively, a pattern of binding to an exemplary array may differ from one strain of influenza B to another strain. In one particular example, one influenza B strain may produce a different pattern distinguishable from another strain based on the particular sequences chosen as capture and/or label probes. In accordance with this example, the pattern formed on an exemplary microarray when a sample contains one influenza B strain can be different from a pattern formed on a microarray from a sample containing a different influenza B strain or lineage.

### Influenza Diagnostics

Current methods for characterizing type A influenza viruses often depend on phenotypic (e.g., antigenic) information. While there is evidence that the high pathogenicity of the H5N1 viruses responsible for the 1997 Hong Kong outbreak in poultry was largely due to enhanced cleavability of the H5 HA, this alone does not explain their ability to infect humans since previous outbreaks of viruses with similarly easily cleavable H5 HAs did not cause human disease. The reason these 1997 H5N1 viruses were able to infect humans is still the subject of investigation, largely focusing on the internal, nonglycoprotein genes from which a complicated picture is emerging. Mouse studies using human H5N1 isolates from the 1997 outbreak have revealed five different amino acids in four genes that might contribute to the host range and/or pathogenicity of these viruses. Thus, phenotypic assays do not provide sufficient information for gauging the potential pathogenicity of a new strain.

Traditional characterization of influenza virus involves hemagglutinin-inhibition serology tests, with viral cultures often necessary for more detailed characterization. These traditional approaches are laborious and time-consuming, making them unsuitable for rapid diagnosis in a clinical or field setting. Perhaps even more significantly, all of the rapid influenza tests are relatively insensitive, so false negatives are often reported when these tests are used.

The feasibility of RT-PCR for the identification of influenza viral genes has been suggested, but the process of amplification and purification is lengthy and the necessary supplies and equipment expensive. Such RT-PCR assays are still laborious and expensive and are not well suited for rapid, field portable diagnostics of influenza types and sub-types.

### Functional Genomics and Microchip-Platforms

With the advent of rapid genome sequencing and large genome databases, it is now possible to utilize genetic information in a myriad of ways. One of the most promising technologies is oligonucleotide arrays. Of the two most commonly used technologies for generating arrays, one is based on photolithography (e.g. Affymetrix) and the other is based on robot-controlled ink jet (spotbot) technology (e.g., Arrayit.com). Other methods for generating microarrays are known and any such known method may be used. Generally, the sequence of the ss-oligonucleotide (capture sequence) placed within a given spot in the array is selected to be complimentary to a single strand of the target sequence within the sample. The aqueous sample is placed in contact with the array under the appropriate hybridization conditions. The array is then washed thoroughly to remove all non-specific adsorbed species. In order to determine whether or not the target sequence was captured, the array is “developed” by adding, typically, a fluorescently labeled oligonucleotide sequence that is complimentary to an unoccupied portion of the target sequence. The microarray can then be “read” using a microarray reader or scanner, which outputs an image of the array. Spots that exhibit strong fluorescence are positive for that particular target sequence.

DNA chip technology has found widespread use in gene expression analysis and there are now several demonstrations of DNA chips in the field of diagnostics.

### DNA Microarray for Differential Detection of Influenza B

In one embodiment, a DNA microarray, for example, a “BChip” apparatus can be used to identify a sample infected with influenza B virus and characterize the strain and/or lineage of the virus in the sample. In accordance with these embodiments, the BChip apparatus may take about 24 hours or less; or about 12 hours or less; or about 8 to 12 hours; or about 8 hours or less, as compared to about 4 days using current state of the art methodology. Apparati contemplated herein can include about 150 oligonucleotide sequences or less, or about 125 oligonucleotide sequences; or less; or 100 oligonucleotide sequences; or about 50 nucleotides or less directed towards one or more target genes of influenza B virus bound to the surface of a solid substrate of the apparatus. One particular embodiment herein includes generating oligonucleotides of at least a portion of a nucleic acid or complimentary nucleic acid of a target gene of influenza B virus. In one particular example, the target gene can include but is not limited to, the M segment, the HA segment, the NA segment and combination thereof.

Embodiments herein have several advantages over the viral assays to date namely assays for identifying strains and or lineages of influenza B. This advantage can allow a rapid and accurate method for identifying the influenza B strain in a given situation permitting prompt intervention to reduce an outbreak, for example. In one embodiment, a chip assay disclosed in herein targets only one gene of a virus. In other embodiments, the multiplex PCR as used in one embodiment, namely, one particular BChip apparatus targets multiple genes. In addition, one array apparatus disclosed herein has a more rapid turn around time for analysis. In accordance with this embodiment, the turnaround time for analysis for the presence or absence of a viral target in a sample may be 12 hours or less; or 10 hours or less; or 8 hours or less. In a particular embodiment, analysis for the presence or absence of a viral target in a sample may be 7 hours or less. In a more particular embodiment, analysis for the presence or absence of a viral target in a sample may be 5 hours or less. In addition, one microarray for detection of an influenza virus disclosed herein may use about 150 sequences or less, preferably 15-100 sequences, more preferably 15-75 sequences and even more preferably less than 50 sequences to identify the presence or absence of an influenza B virus (e.g. HA, NA and/or M segment of influenza B). In accordance with these embodiments, identification of presence or absence of a particular type, subtype, strain or lineage of a virus in a sample may require about 100 nucleotides or less for detection of a target gene indicative of the virus. In one particular example, 50-100 sequences of about 10-30 nucleotides in length may be used to generate an array for identification of the presence or absence of a gene segment of a virus in a sample. In accordance with these embodiments, a skilled artisan understands that many of the sequences generated for detection of the single gene indicative of the viral organism may have overlap.

One issue for developing a DNA microarray to analyze influenza strains is identifying what gene of the viral genome such as the influenza genome to target. For example, each virus is characterized as a strain or lineage due to differences in the evolution of the particular virus. Sequences chosen for an array must preferably distinguish between the various strains of influenza B. Additionally, influenza virus mutates rapidly. Thus, sequences placed on the microarray must preferably take into account the rapid mutational rate of influenza. For example, target genes used to generate an array can include one or more conserved genes or at least a portion of a conserved gene.

A number of studies have examined the utility of microarrays for influenza detection, and all have used a multiple gene approach including HA and NA targets to subtype viruses. While these studies provided proof of concept for microarray detection of influenza, the primary limitation in these studies was the necessity of amplifying multiple genes.

Previously, a set of procedures were developed that permit taking a large number of influenza sequences for an individual gene (>1000) and identify regions within each gene that will permit identification in both the influenza type and subtype of influenza A. The sequences used consisted of both published data (ex., the Influenza Sequence Database (ISD) at the Los Alamos National Laboratory www.flu.lan1.gov), and unpublished (CDC influenza sequence database). This process involves using both preexisting programs as well as programs developed specifically for this task, in one example the program ‘ConFind’ (Smagala et al., “ConFind: a robust tool for conserved sequence identification,” Bioinformatics Advance Access published Oct. 20, 2005, incorporated herein by reference) was used. Using these programs in a workflow system resulted in rapid and efficient identification of regions of the HA and NA genes that could be used for strain differentiation of influenza B.

In one example, the M segment of influenza codes for both the M1 and M2 proteins. M1 is the most abundant protein in the virion and forms the inside of the viral envelope. M1 serves as a bridge between HA, NA, and M2 and the viral core. M1 is involved in a number of steps in the life cycle of the virus, including the transport of the ribonucleoproteins, viral assembly, and budding. M2 is a minor component of the viral envelope that acts as a proton-selective ion channel. Inside the acidic endosome after viral and endosomal membrane fusion, the M2 ion channel opens and facilitates the low-pH environment needed to uncoat the ribonucleoprotein.

Once a target gene is chosen, then certain regions within the target gene can be selected. In accordance with this example, oligonucleotides including at least a portion of the nucleic acid sequence or complimentary sequence of a target gene are made and these oligonucleotides can be used to make an array. For example a chip can be designed for analysis of the gene region of influenza B alone or in combination with other target gene regions. In one particular example, 36 different segment sequences were positioned on a microarray. Of these 36 sequences, 13 sequences were designed to target the HA gene, 14 sequences were designed to target the NA gene and 9 sequences were designed to target the M gene. Appropriate probe sequences (capture and label) were then designed from the conserved regions (see Methods in the Example section). Probe sequences were selected to yield either broad reactivity with all viral subtypes or highly specific reactivity for a given viral subtype or host species. Anticipated reactivity was determined computationally by evaluating the number of mismatches between possible probe sequences and all sequences in the databases used to design them. These sequences were designed to specifically identify influenza B HA, NA or M genes and distinguish lineages of influenza B. The following procedure was used to identify the type and subtype of influenza.
(1) Amplify the viral RNA by first converting it into cDNA using reverse transcriptase and then amplifying the cDNA using -PCR.
(2) Convert the cDNA back into RNA using T7 RNA polymerase.
(3) Fragment the RNA using base catalyzed hydrolysis.
(4) Add a mixture of specific label-oligonucleotides to the fragmented RNA. Only one label oligonucleotide will bind to each region that the microarray is designed to capture.
(5) Place the mixture of fragmented influenza RNA and label-oligos onto the microarray, and allow hybridization to occur.
(6) Wash off any unbound RNA/DNA.
(7) Analyze using a scanning laser fluorimeter.

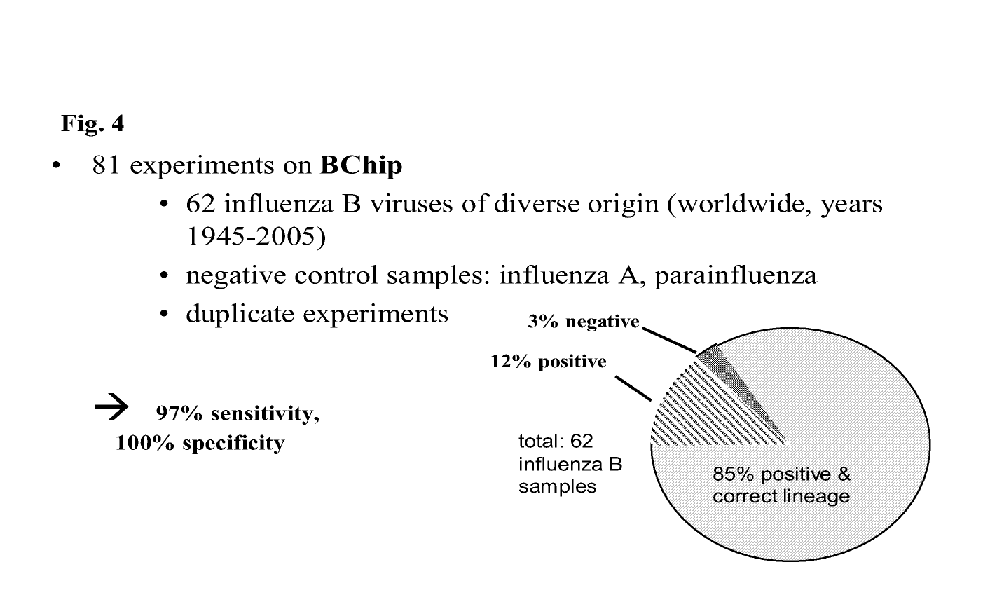

The detailed procedures are described in the Examples section below. In one exemplary study viral isolates of known lineage and subject samples known to be influenza B positive were tested. Methods disclosed herein were used to identify the strain or lineage of each of the samples (see for example, FIG. 4)

In certain more particular embodiments, a BChip™ apparatus accurately distinguished strains or lineages of influenza B viruses in much less time than current procedures.

In certain embodiments herein, it is contemplated that other viruses have an internal non-immunogenic protein similar to the M segment of influenza that may be targeted and capture and label sequences may be produced. From these capture and label sequences, a microarray chip may be created alone or in combination with other target genes for identifying strains or lineages of a virus in a sample. In accordance with these embodiments, other viruses may include negative sense, single-strand, segmented RNA viruses. In one particular embodiment, a negative sense, single-strand, segmented RNA virus may include viruses of the class Orthomyxovyridae. Orthomyxovyridae viruses include but are not limited Influenzavirus A, Influenzavirus B, Influenzavirus C, Thogotovirus and Isavirus.

In other embodiments, unique patterns can be observed in any of the contemplated segment sequences on a microarray and used as a diagnostic test for the identification of unknown influenza B strains or other influenza strains. In accordance with this embodiment, microarray results from unknown viruses could be evaluated against a “training set” or control set using either a simple hierarchical clustering analysis or more advanced methods, for example, neural networks (Filmore, D. Gene expression learned. Mod. Drug. Disc. 7, 47-49 (2004).; Hanai, T. & Honda, H. Application of knowledge information processing methods to biochemical engineering, biomedical and bioinformatics fields. Adv. Biochem. Eng. Biotech. 91, 51-73 (2004) incorporated herein by reference). Other embodiments, concern using any nucleic acid extraction kit such as a DNA or RNA extraction kit for methods disclosed herein. In certain embodiments, methods herein can use spin column, ion exchange column, precipitations, gel chromatography or other chromatography or gel purification technologies to purify or partially purify components of any sample.

In one particular embodiment, a sample can be obtained from a subject or an object and the sample tested for the presence of an influenza B strain by methods disclosed herein. Depending on the type of sample obtained further manipulations of the sample may be required using methods known in the art, before testing the sample for the presence of an influenza B strain. For example, fractionation of the sample may be required or partial purification of the sample, such as filtration, microfiltration, gel chromatography or column chromatography or other methods known in the art. In some embodiments, methods disclosed herein may use a kit for extracting the nucleic acids of a sample, for example, any kit or system known in the art. One kit may be an RNA extraction kit. In other embodiments, a kit can be used to isolate and/or purify clinical specimens, for example to partially or completely purify a component of a sample. In some embodiments, centrifugation columns may be used to filter or separate components of a sample or a nucleic acid preparation. Some embodiments contemplate that spin technology can be used, for example, spin columns with various resins for separation of sample components (e.g. Qiagen silica column technologies). Other embodiments for amplification of nucleic acid sequences may concern PCR-based technologies, or any other amplification technologies known in the art.

### Kits

In still further embodiments, embodiments herein concern kits for compositions, methods and apparati described herein. In one embodiment, a viral (such as a pathogenic or non-pathogenic virus) detection kit is contemplated. In another embodiment, a kit for analysis of a sample from a subject having or suspected of developing a virally-induced infection is contemplated. In a more particular embodiment, a kit for analysis of a sample from a subject having or suspected of developing an influenza-induced infection is contemplated. In accordance with this embodiment, the kit may be used to assess the type, subtype or strain of the virus.

The kits may include a microarray chip system within a tube or other suitable vessel. In addition, the kit may include a stick or specialized paper such as a dipping stick or dipping paper capable of rapidly analyzing a sample for example, within a healthcare facility by a healthcare provider. In another embodiment, the kit may be a portable kit for use at a specified location outside of a healthcare facility.

The container means of any of the kits contemplated herein will generally include at least one vial, test tube, flask, bottle, syringe or other container means, into which the testing agent, may be preferably and/or suitably aliquoted. Kits herein may also include a means for comparing the results such as a suitable control sample such as a positive and negative control. A suitable positive control may include a sample of a known viral type, subtype or strain.

### Nucleic Acids

In various embodiments, isolated nucleic acids may be analyzed to detect and/or diagnosis types, subtypes or even strains of influenza virus. The isolated nucleic acid may be derived from genomic RNA or complementary DNA (cDNA). In other embodiments, isolated nucleic acids, such as chemically or enzymatically synthesized DNA, may be of use for capture probes, primers and/or labeled detection oligonucleotides.

A “nucleic acid” includes single-stranded and double-stranded molecules, as well as, DNA, RNA, chemically modified nucleic acids and nucleic acid analogs. It is contemplated that a nucleic acid may be of 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, about 110, about 120, about 130, about 140, about 150, about 160, about 170, about 180, about 190, about 200, about 210, about 220, about 230, about 240, about 250, about 275, about 300, about 325, about 350, about 375, about 400, about 425, about 450, about 475, about 500, about 525, about 550, about 575, about 600, about 625, about 650, about 675, about 700, about 725, about 750, about 775, about 800, about 825, about 850, about 875, about 900, about 925, about 950, about 975, about 1000, about 1100, about 1200, about 1300, about 1400, about 1500, about 1750, about 2000 or greater nucleotide residues in length, for example, up to a full length protein encoding sequence, or a regulatory genetic element, or, even, in some embodiments, including ‘silent’ genetic elements.

### Construction of Nucleic Acids

Isolated nucleic acids may be made by any method known in the art, for example using standard recombinant methods, synthetic techniques, or combinations thereof. In some embodiments, the nucleic acids may be cloned, amplified, or otherwise constructed.

The nucleic acids may conveniently comprise sequences in addition to a type, subtype or strain associated viral sequence. For example, a multi-cloning site comprising one or more endonuclease restriction sites may be added. A nucleic acid may be attached to a vector, adapter, or linker for cloning of a nucleic acid. Additional sequences may be added to such cloning and sequences to optimize their function, to aid in isolation of the nucleic acid, or to improve the introduction of the nucleic acid into a cell. Use of cloning vectors, expression vectors, adapters, and linkers is well known in the art.

### Recombinant Methods for Constructing Nucleic Acids

Isolated nucleic acids may be obtained from viral or other sources using any number of cloning methodologies known in the art. In some embodiments, oligonucleotide probes which selectively hybridize, under stringent conditions, to the nucleic acids are used to identify a viral sequence. Methods for construction of nucleic acid libraries are known and any such known methods may be used. [See, e.g., Current Protocols in Molecular Biology, Ausubel, et al., Eds., Greene Publishing and Wiley-Interscience, New York (1995); Sambrook, et al., Molecular Cloning: A Laboratory Manual, 2nd Ed., Cold Spring Harbor Laboratory Vols. 1-3 (1989); Methods in Enzymology, Vol. 152, Guide to Molecular Cloning Techniques, Berger and Kimmel, Eds., San Diego: Academic Press, Inc. (1987).]

### Nucleic Acid Screening and Isolation

Viral RNA or cDNA may be screened for the presence of an identified genetic element of interest using a probe based upon one or more sequences. Various degrees of stringency of hybridization may be employed in the assay. As the conditions for hybridization become more stringent, there must be a greater degree of complementarity between the probe and the target for duplex formation to occur. The degree of stringency may be controlled by temperature, ionic strength, pH and/or the presence of a partially denaturing solvent such as formamide. For example, the stringency of hybridization is conveniently varied by changing the concentration of formamide within the range of 0% to 50%. The degree of complementarity (sequence identity) required for detectable binding will vary in accordance with the stringency of the hybridization medium and/or wash medium. The degree of complementarity will optimally be 100 percent; however, minor sequence variations in the influenza RNA that result in <100% complementarity between the influenza RNA and capture sequences, probes and primers may be compensated for by reducing the stringency of the hybridization and/or wash medium.

High stringency conditions for nucleic acid hybridization are well known in the art. For example, conditions may comprise low salt and/or high temperature conditions, such as provided by about 0.02 M to about 0.15 M NaCl at temperatures of about 50° C. to about 70° C. Other exemplary conditions are disclosed in the following Examples. It is understood that the temperature and ionic strength of a desired stringency are determined in part by the length of the particular nucleic acid(s), the length and nucleotide content of the target sequence(s), the charge composition of the nucleic acid(s), and to the presence or concentration of formamide, tetramethylammonium chloride or other solvent(s) in a hybridization mixture. Nucleic acids may be completely complementary to a target sequence or may exhibit one or more mismatches.

### Nucleic Acid Amplification

Nucleic acids of interest may also be amplified using a variety of known amplification techniques. For instance, polymerase chain reaction (PCR) technology may be used to amplify target sequences directly from viral RNA or cDNA. PCR and other in vitro amplification methods may also be useful, for example, to clone nucleic acid sequences, to make nucleic acids to use as probes for detecting the presence of a target nucleic acid in samples, for nucleic acid sequencing, or for other purposes. Examples of techniques of use for nucleic acid amplification are found in Berger, Sambrook, and Ausubel, as well as Mullis et al., U.S. Pat. No. 4,683,202 (1987); and, PCR Protocols A Guide to Methods and Applications, Innis et al., Eds., Academic Press Inc., San Diego, Calif. (1990). PCR-based screening methods have been disclosed. [See, e.g., Wilfinger et al. BioTechniques, 22(3): 481-486 (1997).]

### Synthetic Methods for Constructing Nucleic Acids

Isolated nucleic acids may be prepared by direct chemical synthesis by methods such as the phosphotriester method of Narang et al., Meth. Enzymol. 68:90-99 (1979); the phosphodiester method of Brown et al., Meth. Enzymol. 68:109-151 (1979); the diethylphosphoramidite method of Beaucage et al., Tetra. Lett. 22:859-1862 (1981); the solid phase phosphoramidite triester method of Beaucage and Caruthers, Tetra. Letts. 22(20):1859-1862 (1981), using an automated synthesizer as in Needham-VanDevanter et al., Nucleic Acids Res., 12:6159-6168 (1984); or by the solid support method of U.S. Pat. No. 4,458,066. Chemical synthesis generally produces a single stranded oligonucleotide. This may be converted into double stranded DNA by hybridization with a complementary sequence, or by polymerization with a DNA polymerase using the single strand as a template. While chemical synthesis of DNA is best employed for sequences of about 100 bases or less, longer sequences may be obtained by the ligation of shorter sequences.

### Covalent Modification of Nucleic Acids

A variety of cross-linking agents, alkylating agents and radical generating species may be used to bind, label, detect, and/or cleave nucleic acids. For example, Vlassov, V. V., et al., Nucleic Acids Res (1986) 14:4065-4076, disclose covalent bonding of a single-stranded DNA fragment with alkylating derivatives of nucleotides complementary to target sequences. A report of similar work by the same group is that by Knorre, D. G., et al., Biochimie (1985) 67:785-789. Iverson and Dervan also showed sequence-specific cleavage of single-stranded DNA mediated by incorporation of a modified nucleotide which was capable of activating cleavage (J Am Chem Soc (1987) 109:1241-1243). Meyer, R. B., et al., J Am Chem Soc (1989) 111:8517-8519 disclose covalent crosslinking to a target nucleotide using an alkylating agent complementary to the single-stranded target nucleotide sequence. A photoactivated crosslinking to single-stranded oligonucleotides mediated by psoralen was disclosed by Lee, B. L., et al., Biochemistry (1988) 27:3197-3203. Use of crosslinking in triple-helix forming probes was also disclosed by Home, et al., J Am Chem Soc (1990) 112:2435-2437. Use of N4, N4-ethanocytosine as an alkylating agent to crosslink to single-stranded oligonucleotides has also been disclosed by Webb and Matteucci, J Am Chem Soc (1986) 108:2764-2765; Nucleic Acids Res (1986) 14:7661-7674; Feteritz et al., J. Am. Chem. Soc. 113:4000 (1991). Various compounds to bind, detect, label, and/or cleave nucleic acids are known in the art. See, for example, U.S. Pat. Nos. 5,543,507; 5,672,593; 5,484,908; 5,256,648; and, 5,681941.

### Nucleic Acid Labeling

In various embodiments, tag nucleic acids may be labeled with one or more detectable labels to facilitate identification of a target nucleic acid sequence bound to a capture probe on the surface of a microchip. A number of different labels may be used, such as fluorophores, chromophores, radio-isotopes, enzymatic tags, antibodies, chemiluminescent, electroluminescent, affinity labels, etc. One of skill in the art will recognize that these and other label moieties not mentioned herein can be used. Examples of enzymatic tags include urease, alkaline phosphatase or peroxidase. Colorimetric indicator substrates can be employed with such enzymes to provide a detection means visible to the human eye or spectrophotometrically. A well-known example of a chemiluminescent label is the luciferin/luciferase combination.

In preferred embodiments, the label may be a fluorescent, phosphorescent or chemiluminescent label. Exemplary photodetectable labels may be selected from the group consisting of Alexa 350, Alexa 430, AMCA, aminoacridine, BODIPY 630/650, BODIPY 650/665, BODIPY-FL, BODIPY-R6G, BODIPY-TMR, BODIPY-TRX, 5-carboxy-4′,5′-dichloro-2′,7′-dimethoxy fluorescein, 5-carboxy-2′,4′,5′,7′-tetrachlorofluorescein, carboxyfluorescein, 5-carboxyrhodamine, 6-carboxyrhodamine, 6-carboxytetramethyl amino, Cascade Blue, Cy2, Cy3, Cy3,5, Cy5, Cy5,5, 6-FAM, dansyl chloride, Fluorescein, HEX, 6-JOE, NBD (7-nitrobenz-2-oxa-1,3-diazole), Oregon Green 488, Oregon Green 500, Oregon Green 514, Pacific Blue, phthalic acid, terephthalic acid, isophthalic acid, cresyl fast violet, cresyl blue violet, brilliant cresyl blue, para-aminobenzoic acid, erythrosine, phthalocyanines, azomethines, cyanines, xanthines, succinylfluoresceins, rare earth metal cryptates, europium trisbipyridine diamine, a europium cryptate or chelate, diamine, dicyanins, La Jolla blue dye, allopycocyanin, allococyanin B, phycocyanin C, phycocyanin R, thiamine, phycoerythrocyanin, phycoerythrin R, REG, Rhodamine Green, rhodamine isothiocyanate, Rhodamine Red, ROX, TAMRA, TET, TRIT (tetramethyl rhodamine isothiol), Tetramethylrhodamine, and Texas Red. These and other labels are available from commercial sources, such as Molecular Probes (Eugene, Oreg.).

### Examples

The following examples are included to illustrate various embodiments. It should be appreciated by those of skill in the art that the techniques disclosed in the examples which follow represent techniques discovered to function well in the practice of the claimed methods, compositions and apparatus. However, those of skill in the art should, in light of the present disclosure, appreciate that many changes may be made in the specific embodiments which are disclosed and still obtain a like or similar result without departing from the spirit and scope of the invention.

### Materials and Methods

Capture and label sequence selection were performed by the same processes. One exemplary method of capture/label sequence selection for the influenza microarray was described in detail previously (see Mehlmann et al., Robust Sequence Selection Method Used To Develop the FluChip Diagnostic Microarray for Influenza Virus, Journal of Clinical Microbiology 2006, 44, 2857-2862, incorporated herein by reference in it's entirety). Briefly, databases of three gene segments, HA, NA, and M of influenza B were compiled using the Los Alamos National Laboratories (LANL) influenza database (http://www.flu.lan1.gov) and the Centers for Disease Control and Prevention influenza databases. The HA database was limited to influenza B viruses from the years 2000-2005. Following phylogenetic analysis of each of the three databases, conserved regions were identified for sub-portions of the database, allowing discrimination between the different lineages. In one exemplary method, capture/label sequences were obtained from conserved regions of 45 nt or more in length; both capture/label sequences were in one example between 16 and 25 nt in length, and the capture/label pair were separated by a single nucleotide gap. Capture/label pairs were designed to be employed in a two-step hybridization method. In one method “capture” sequences were bound to a solid surface (Operon Biotechnologies, Inc., Huntsville, Ala.) and used to capture or bind amplified viral RNA. Then, the exemplary 5′-Quasar 570-modified “label” sequences (Biosearch Technologies, Inc., Novato, Calif.) served as the fluorescence probe. Possible cross-reactive capture/label pairs (i.e., capture sequences that hybridized to label sequences resulted in a false positive) were identified experimentally and were excluded from the final microarray layout. In addition, an internal positive control to test hybridization efficiency was added that included a positive control (PC) capture sequence and a fluorescence-labeled complementary label sequence.

FIG. 5 illustrates changes in the influenza type B vaccine strain recommendation by the WHO during 1973-2007. Since 1999 there have been two recommendations per year, one for the northern hemisphere (N) and the other for the southern hemisphere (S). White bars indicate virus strains before the lineage split occurred; grey bars represent Yam88-like and black bars Vic87-like strains.

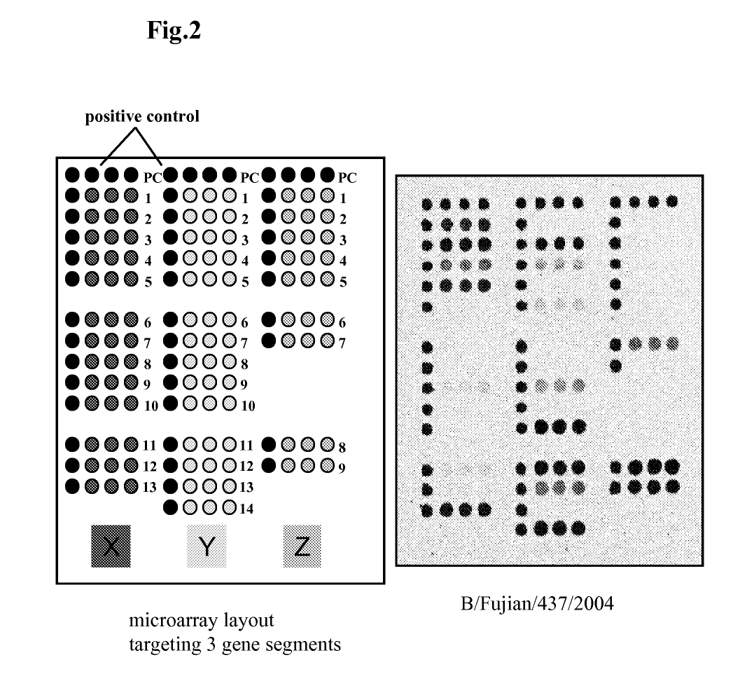

Microarray layout. As shown in FIG. 2A, one exemplary influenza B microarray contained 36 capture probes spotted in triplicate, as well as a positive control (PC) sequence that also served as a position marker. Two identical microarrays were printed on each slide. The 5′-amino-C6-modified capture probes were spotted onto aldehyde-modified glass microscope slides VALS-25 (CEL Associates, Inc., Pearland, Tex.) under optimized conditions previously described (see Dawson et. al. Spotting optimization for oligo microarrays on aldehyde glass. Anal Biochem 2005, 341: 352-360) using a Genetix OmniGrid microarray spotter (Genetix, Boston, Mass.).

Virus samples. Influenza virus samples were provided by the Centers for Disease Control and Prevention, Atlanta. A human parainfluenza virus sample was provided by the Colorado Department of Health and Environment. All samples were viral isolates, propagated either in embryonated eggs or in MDCK cell cultures by methods known in the art (see also: Kendal and Skehe, Concepts and Procedures for Laboratory-based Influenza Surveillance. 1982 Department of Health and Human Services, Centers for Diseases Control. Washington, D.C.) Virus type and lineage was determined by hemagglutination inhibition (HI) assay at the CDC.

RNA isolation and amplification. In one exemplary method, viral RNA was extracted from influenza virus samples using either the MagNA Pure LC system (Roche, Indianapolis, Ind.) or the RNeasy kit (Qiagen, Valencia, Calif.). Extracted RNA was stored at −80° C. until further use. Reverse-transcription polymerase chain reaction (RT-PCR), followed by run-off transcription, was employed to amplify extracted viral RNA. The RT step was performed using Superscript II Reverse Transcriptase (Invitrogen Corp., Carlsbad, Calif.) and SZA+/SZB+ universal influenza primers as described previously. Subsequently, the HA, NA, and M gene segment were amplified in a multiplex PCR step using Taq Polymerase (Invitrogen Corp., Carlsbad, Calif.) and gene-specific primers (HA forward: ATC CAC AAA ATG AAG GCA SEQ ID NO:1; NA forward AGC AGA AGC AGA GCA TCT TCT CAA SEQ ID NO:2; HA/NA reverse: ACT AGT AAC AAG AGC ATT TTT C SEQ ID NO:3; M forward: AGC AGA AGC ACG CAC TTT C SEQ ID NO:4; M reverse: AAA CAA CGC ACT TTT TCC SEQ ID NO:5). PCR amplification was confirmed by identifying DNA of appropriate length on a 1% agarose gel (35 min at 100V) stained with ethidium bromide. PCR reverse primers contained a T7 promoter site that allowed subsequent run-off transcription using T7 RNA polymerase (Invitrogen Corp., Carlsbad, Calif.). Transcribed RNA was kept at −20° C. for immediate use and at −80° C. for long-term storage.

RNA fragmentation and hybridization. Transcribed RNA was fragmented prior to microarray hybridization as described (see Mehlmann et al., Robust Sequence Selection Method Used to Develop the FluChip Diagnostic Microarray for Influenza Virus, Journal of Clinical Microbiology 2006, 44, 2857-2862). Fragmented RNA was mixed with label sequences and hybridized to the microarray as previously described. In one example, fluorescence read-out was conducted with a VersArray ChipReader (Bio-Rad, Hercules, Calif.) using the 532 nm excitation channel, a laser power of 60%, a PMT sensitivity of 700 V, and 5 urn resolution. The resulting images were processed with VersArray Analyzer software (Bio-Rad, Hercules, Calif.). Images shown in this study were contrast-enhanced for improved visualization.

Data analysis. For each capture probe, background-corrected mean intensity values and signal-to-noise (S/N) ratios (mean net intensity/standard deviation of background) were obtained. The test for influenza B was considered positive when the S/N values were >10 for at least one capture probe. For artificial neural network-based lineage analysis, in order to minimize the influence of slide-to-slide variations, relative intensity values were calculated for the 13 HA capture probes, assigning 100% to the highest mean HA spot intensity on each image.

Influenza B lineage discrimination using an artificial neural network (ANN). In one example, the commercially available software package EasyNN-Plus 7.0c (Neural Planner Software, Cheshire, England) was used to develop the ANN model, using a feed-forward method with weighted back-propagation. The ANN utilized 14 input nodes (13 relative intensities and the highest mean intensity of HA capture probes), a hidden layer with 8 nodes, and 2 output nodes (“Yam88” and “Vic87” with values of 1 or 0, designating true or false, respectively).

Initial type and lineage assignments were conducted on blinded samples by visual inspection of the microarray images, with excellent results. However, the purpose of the ANN was to automate the process and remove any user subjectivity. Of the 62 influenza B viruses initially processed, 12 were excluded from the neural network analysis in order to proceed. Specifically, 7 older influenza B viruses that originated in years before the lineage split occurred, and 5 influenza B viruses that had S/N<10 for HA sequences were excluded from the ANN analysis. Thus, 50 influenza B viruses, some of which were processed in duplicate, as well as some negative controls, were used in combination with the ANN. Two separate experiments were conducted in order to test all of the virus samples. In one experiment half of the over 60 images were randomly selected and used to train and validate the ANN, the other half were then tested as “unknowns.” In the second experiment, the two sets of data were reversed (i.e., the previous training/validation set was treated and evaluated as unknowns). Learning rate and momentum were both optimized by the software. The learning process was stopped after 101 cycles when the average target error was below 0.005. The average training error was found to be ˜1.5×10⁴. A minimum output value of 0.9 was set as a threshold for a positive assignment as either Yam88 or Vic87.

### Example 1

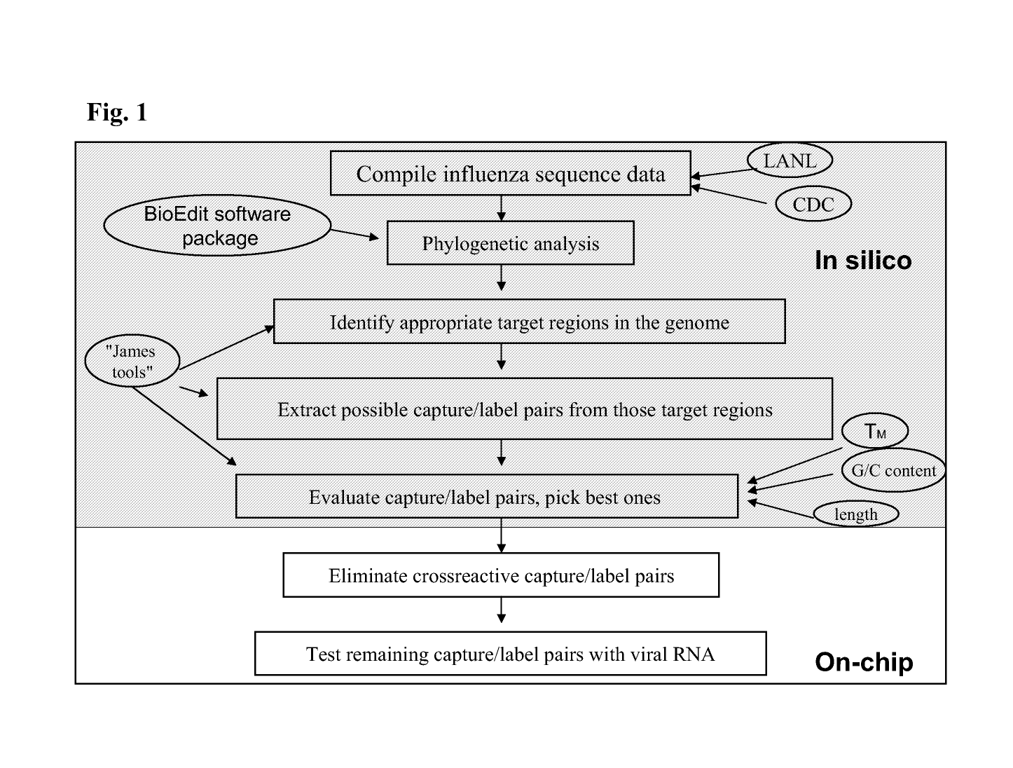

FIG. 1 represents an exemplary schematic of an exemplary sequence selection process for generating an array bound to a solid surface.

FIG. 2A is a graphical representation of BChip microarray layout. The microarray contained three sections: in the left section are 13 capture sequences, each in triplicate, that target different regions of the HA gene segment of influenza B viruses; the middle section contains 14 NA capture sequences; and sequences in the right section target the M gene segment. Positive control (PC) sequences may serve as position markers, to ensure that the hybridization step worked properly or both. Here, the positive control serves as both a position marker and to ensure the hybridization is working correctly. Briefly, the assay involves extraction of viral RNA, nucleic acid amplification through RT-PCR followed by run-off transcription, and finally fragmentation and hybridization of amplified viral RNA to the microarray.

In this example, FIG. 2B illustrates that all three sections of the microarray exhibit fluorescence signals for B/Fujian/43-7/2004, indicating successful multiplex RT-PCR amplification and surface-capture for all three gene segments. The relative fluorescence intensities of the different capture sequences vary, and that, as designed, not all capture sequences show hits with this particular sample. The presence or absence of signal for specific capture sequences can be used for lineage discrimination.

FIGS. 2A and 2B represent exemplary microarray layouts of an exemplary BChip (2A) and example image (2B) of virus sample B/Fujian/437/2004. Black symbols represent the positive control sequences. Each capture sequence was spotted in triplicate. For the fluorescence images, darker shades represent higher fluorescence.

Detection of influenza type B viruses. A total of 65 samples were analyzed on the BChip, including 62 different influenza B positive samples that originated from locations worldwide and covered the years 1945 to 2005. Additionally, two control samples of influenza A, representing the two subtypes currently circulating in humans (H3N2 and H1N1), and one sample of human parainfluenza virus type 1, a common virus causing influenza-like illness, served as negative control samples.

A summary of microarray and the artificial neural network results is represented in Table 1. The decision whether a sample tested positive or negative was based on the highest S/N value of all capture probe signals on the microarray. A threshold of S/N>10 for a positive test was used. As can be seen in Table 1, in some cases the signals were below the threshold. In this example, in the event one or more gene segment was detected, the sample was considered positive for influenza type B. Overall, detection of influenza B virus BChip assay resulted in a clinically defined sensitivity of 97% and a specificity of 100% for the detection of influenza B (these samples were viral isolates and not clinical samples). This data is represented in an exemplary pie diagram in FIG. 4.

TABLE 1
BChip and Neural Network Results.

| Sample information | | S/N values | | | | ANN output | | |
|---|---|---|---|---|---|---|---|---|
| ID | HA lineage | HA | NA | M | pos/neg | Yam88 | Vic87 | |
| B/Baker/45 | NA | 1.6 | 2.2 | 2.1 | x | | | |
| B/Muelder/45 | NA | 0.6 | 25.6 | 6.9 | ✓ | | | |
| B/Peacock/45 | NA | 1.3 | 2.2 | 1.7 | x | | | |
| B/Colorado/1/65 | NA | 1.0 | 296.0 | 80.6 | ✓ | | | |
| B/Michigan/1/66 | NA | 3.9 | 452.5 | 159.1 | ✓ | | | |
| B/Ann Arbon/2/74 | NA | 73.2 | 465.0 | 123.6 | ✓ | | | |
| B/Ann Arbon/1/76 | NA | 348.8 | 705.1 | 154.5 | ✓ | | | |
| B/Panama/45/90 | Yam88 | 51.0 | 70.5 | 27.5 | ✓ | 1.00 | 0.00 | ✓ |
| B/Argentina/218/57 | Yam88 | 425.4 | 436.2 | 335.5 | ✓ | 1.00 | 0.00 | ✓ |
| B/Paris/459/99 | Yam88 | 889.9 | 744.7 | 557.4 | ✓ | 1.00 | 0.00 | ✓ |
| B/Johannesburg/5/99 | Yam88 | 328.4 | 231.0 | 79.8 | ✓ | 0.99 | 0.01 | ✓ |
| B/Hawaii/2/2000 | Yam88 | 13.6 | 45.4 | 5.7 | ✓ | 0.99 | 0.01 | ✓ |
| B/Moscow/4/2000 | Yam88 | 148.0 | 427.4 | 82.6 | ✓ | 0.99 | 0.01 | ✓ |
| B/Guangdong/120/2000 | Yam88 | 60.4 | 377.5 | 65.5 | ✓ | 0.98 | 0.02 | ✓ |
| B/Guangdong/299/2001 | Yam88 | 157.2 | 152.5 | 55.0 | ✓ | 1.00 | 0.00 | ✓ |
| B/Bucharest/676/2001 | Yam88 | 404.9 | 532.4 | 26.2 | ✓ | 1.00 | 0.00 | ✓ |
| B/Sichuan/34/2001 | Vic67 | 65.2 | 385.2 | 45.9 | ✓ | 0.05 | 0.95 | ✓ |
| B/Minnesota/14/2001 | Yam88 | 2.8 | 54.6 | 13.8 | ✓ | | | LS |
| B/Taiwan/1484/2001 | Vic87 | 4.0 | 7.6 | 32.0 | ✓ | | | LS |
| B/Wichan/359/2001 | Yam88 | 73.6 | 90.0 | 8.7 | ✓ | 1.00 | 0.00 | ✓ |
| B/Chile/5068/2001 | Yam88 | 161.7 | 72.1 | 18.0 | ✓ | 1.00 | 0.00 | ✓ |
| B/Hawaii/35/2001 | Vic87 | 37.5 | 95.0 | 21.1 | ✓ | 0.06 | 0.93 | ✓ |
| B/Singapore/67204/2001 | Yam88 | 154.7 | 78.0 | 18.8 | ✓ | 1.00 | 0.00 | ✓ |
| B/Philippines/70299/2001 | Yam88 | 13.4 | 11.9 | 1.7 | ✓ | 1.00 | 0.00 | ✓ |
| B/Mississippi/3/2001 | Yam88 | 61.2 | 93.0 | 25.3 | ✓ | 1.00 | 0.00 | ✓ |
| B/Texas/11/2001 | Yam88 | 495.4 | 264.3 | 75.7 | ✓ | 1.00 | 0.00 | ✓ |
| B/Thailand/80835/2001 | Yam88 | 105.1 | 177.4 | 52.5 | ✓ | 0.97 | 0.03 | ✓ |
| B/Mexico/418/2001 | Yam88 | 340.4 | 133.4 | 28.1 | ✓ | 1.00 | 0.00 | ✓ |
| B/Oman/16304/2001 | YaM88 | 25.4 | 146.9 | 12.4 | ✓ | 0.95 | 0.04 | ✓ |
| B/India/7600/2001 | Vic87 | 80.2 | 224.8 | 71.1 | ✓ | 0.00 | 1.00 | ✓ |
| B/Brisbane/32/2002 | Vic87 | 111.9 | 334.4 | 345.0 | ✓ | 0.00 | 1.00 | ✓ |
| B/China/118180/2002 | Yam88 | 3.1 | 36.2 | 21.9 | ✓ | | | LS |
| B/China/109892/2002 | Yam88 | 111.6 | 492.1 | 481.7 | ✓ | 1.00 | 0.00 | ✓ |
| B/Egypt/2267/2002 | Vic67 | 116.0 | 660.1 | 368.7 | ✓ | 0.48 | 0.82 | NA |
| B/Taiwan/143999/2002 | Yam88 | 60.3 | 344.6 | 116.2 | ✓ | 0.92 | 0.07 | ✓ |
| B/South Carolina/3/2003 | Vic87 | 18.7 | 395.3 | 37.2 | ✓ | 0.86 | 0.12 | NA |
| B/Hong Kong/553/2003 | Vic87 | 7.0 | 527.9 | 84.0 | ✓ | | | LS |
| B/South Carolina/4/2003 | Vic87 | 313.8 | 1375.9 | 532.7 | ✓ | 0.00 | 1.00 | ✓ |
| B/Washington/3/2003 | Yam88 | 173.0 | 356.7 | 138.7 | ✓ | 1.00 | 0.00 | ✓ |
| B/Fujian/437/2004 | Yam88 | 61.2 | 220.3 | 66.4 | ✓ | 1.00 | 0.00 | ✓ |
| B/Hong Kong/310/2004 | Vic67 | 46.7 | 185.4 | 60.9 | ✓ | 0.40 | 0.61 | NA |
| B/Hong Kong/64/2004 | Yam88 | 4.3 | 23.0 | 20.7 | ✓ | | | LS |
| B/Hong Kong/64/2004* | Yam88 | 14.8 | 23.5 | 26.6 | ✓ | 1.00 | 0.00 | ✓ |
| B/Shizuoka/02/2004 | Yam88 | 41.4 | 223.0 | 112.6 | ✓ | 0.98 | 0.02 | ✓ |
| B/Shizuoka/02/2004* | Yam88 | 178.4 | 522.0 | 647.7 | ✓ | 0.99 | 0.01 | ✓ |
| B/Egypt/2040/2004 | Yam88 | 536.0 | 1074.2 | 39.6 | ✓ | 1.00 | 0.00 | ✓ |
| B/Hawaii/10/2004 | Vic87 | 52.9 | 143.0 | 15.8 | ✓ | 0.01 | 0.99 | ✓ |
| B/Florida/7/2004 | Yam88 | 414.9 | 275.9 | 119.2 | ✓ | 1.00 | 0.00 | ✓ |
| B/Hawaii/33/2004 | Vic87 | 126.9 | 265.3 | 215.6 | ✓ | 0.03 | 0.97 | ✓ |
| B/Colorado/13/2004 | Yam88 | 91.0 | 75.8 | 41.1 | ✓ | 1.00 | 0.00 | ✓ |
| B/Malaysia/2506/2004 | Vic87 | 100.7 | 168.3 | 148.9 | ✓ | 0.00 | 1.00 | ✓ |
| B/Kansas/01/2005 | Yam88 | 163.1 | 227.0 | 56.8 | ✓ | 1.00 | 0.00 | ✓ |
| B/Kansas/01/2005* | Yam88 | 105.3 | 130.1 | 83.3 | ✓ | 1.00 | 0.00 | ✓ |
| B/Kansas/01/2005* | Yam88 | 134.1 | 76.6 | 27.6 | ✓ | 1.00 | 0.00 | ✓ |
| B/Kentucky/04/2005 | Yam88 | 46.1 | 180.5 | 27.5 | ✓ | 1.00 | 0.00 | ✓ |
| B/Kentucky/04/2005* | Yam88 | 101.0 | 82.6 | 10.0 | ✓ | 1.00 | 0.00 | ✓ |
| B/Mexico/18/2005 | Yam88 | 90.9 | 285.7 | 31.4 | ✓ | 1.00 | 0.00 | ✓ |
| B/Mexico/18/2005* | Yam88 | 110.7 | 70.2 | 9.8 | ✓ | 1.00 | 0.00 | ✓ |
| B/Texas/10/2005 | Yam88 | 61.0 | 76.1 | 34.1 | ✓ | 1.00 | 0.00 | ✓ |
| B/Texas/10/2005* | Yam88 | 166.1 | 308.2 | 86.4 | ✓ | 1.00 | 0.00 | ✓ |
| B/Alaska/06/2005 | Yam88 | 65.8 | 91.1 | 34.4 | ✓ | 1.00 | 0.00 | ✓ |
| B/Alaska/06/2005* | Yam88 | 392.5 | 381.3 | 100.0 | ✓ | 1.00 | 0.00 | ✓ |
| B/Brazil/136/2005 | Vic87 | 6.7 | 32.2 | 18.2 | ✓ | | | LS |
| B/Brazil/136/2005* | Vic87 | 21.1 | 62.0 | 51.1 | ✓ | 0.00 | 1.00 | ✓ |
| B/Brazil/136/2005* | Vic87 | 50.5 | 144.3 | 62.0 | ✓ | 0.00 | 1.00 | ✓ |
| B/Illinois/36/2005 | Vic87 | 66.6 | 410.2 | 98.6 | ✓ | 0.00 | 1.00 | ✓ |
| B/Illinois/36/2005* | Vic87 | 184.7 | 463.0 | 89.8 | ✓ | 0.00 | 1.00 | ✓ |
| B/Georgia/02/2005 | Vic87 | 26.1 | 177.2 | 71.2 | ✓ | 0.00 | 1.00 | ✓ |
| B/Georgia/02/2005* | Vic87 | 53.4 | 138.6 | 41.8 | ✓ | 0.00 | 1.00 | ✓ |
| B/North Carolina/01/2005 | Yam88 | 94.1 | 226.4 | 81.5 | ✓ | 1.00 | 0.00 | ✓ |
| B/North Carolina/01/2005* | Yam88 | 461.6 | 303.9 | 138.6 | ✓ | 1.00 | 0.00 | ✓ |
| B/Mississippi/4/2005 | Yam88 | 230.0 | 238.7 | 63.0 | ✓ | 1.00 | 0.00 | ✓ |
| B/Mississippi/4/2005* | Yam88 | 131.1 | 127.2 | 71.8 | ✓ | 1.00 | 0.00 | ✓ |
| B/Chio/1/2005 | Vic87 | 70.8 | 110.7 | 70.6 | ✓ | 0.01 | 0.99 | ✓ |
| B/Illinois/47/2005 | Vic87 | 186.8 | 233.1 | 189.5 | ✓ | 0.06 | 0.92 | ✓ |
| B/Utah/1/2005 | Yam88 | 1.7 | 185.7 | 68.5 | ✓ | | | LS |
| Parainfluenza | | 2.5 | 3.0 | 1.6 | x | | | |
| A/H3N2 | | 0.7 | 1.2 | 1.5 | x | | | |
| A/H3N2** | | 1.2 | 2.4 | 1.7 | x | | | |
| A/H1N1 | | 0.3 | 1.0 | 0.5 | x | | | |
| A/H1N1** | | 1.8 | 4.3 | 1.5 | x | | | |

NA = not assigned;
LS = low signal in HA region, therefore not used for ANN analysis;
*= duplicate experiment to examine slide-to-slide variations;
**HA, NA, and M gene segments were amplified by RT-PCR using primers specific for influenza A.

In one exemplary method, out of the 62 influenza B viruses tested, only two samples, both dating from 1945, were not detected on the microarray. These two samples also showed no signal when tested by gel electrophoresis, indicating that multiplex RT-PCR amplification had failed for all three gene segments. The experiment was repeated using RT-PCR amplification of only the HA gene segment, and both samples showed positive signal on the microarray (data not shown). This exemplary BChip assay detected viruses over 60 years old even though the selection of capture/label sequences for the HA segment as well as primer design was based on an influenza HA gene database containing viruses from the years 2000-2005.

All negative control experiments using influenza A, parainfluenza, and multiple negative controls without RNA template (data not shown) were correctly identified as negative for influenza B, (e.g. the method produced no false positive results). In an additional negative control experiment, RT-PCR was performed on two influenza A samples utilizing HA, NA, and M gene primers specific for influenza A. The amplified influenza A viral RNA was analyzed on the microarray and resulted in a negative for influenza B. The lack of cross-reactivity between influenza A viral RNA and influenza B capture sequences is encouraging for future influenza diagnostics as it would be necessary for any combined test for influenza of both types, A and B.

### Example 2

Lineage determination of influenza B. In one exemplary method, in addition to the detection of influenza B with high accuracy, an exemplary BChip was designed to discriminate between the two currently circulating lineages of influenza B (Yam88-like and Vic87-like viruses). In order to do so, the relative fluorescence signal intensity pattern of the HA section of the microarray was utilized. The HA capture/label pair sequences were derived from conserved regions of the B/HA gene segment that were either specific for Yam88-like viruses, specific for Vic87-like viruses, or broadly reactive for all influenza B viruses. Therefore, differences in the relative signal pattern were expected to occur, allowing for lineage identification of the sample tested.

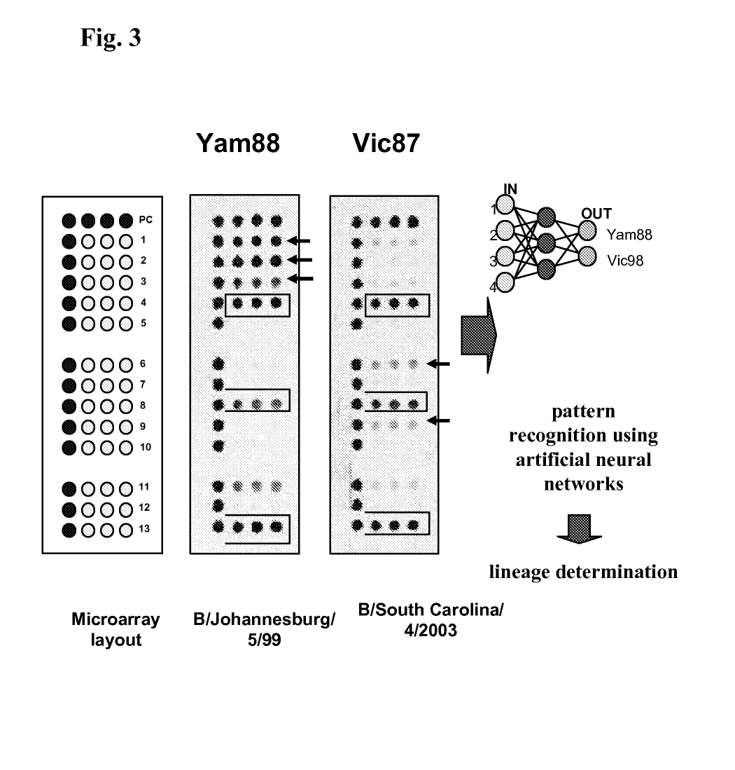

In one exemplary method, illustrated in FIG. 3A-3C HA regions were shown to have representative microarray images for Yam88-like and Vic87-like viruses. Visual inspection revealed a distinct difference in relative signal patterns between the lineages. Comparing these HA patterns, it can be seen that capture sequences HA-1, 2, and 3 exhibited strong signals for Yam88-like viruses (the top row in FIG. 3 represents a positive control), while capture sequences HA-6 and 9, were indicative of Vic87-like viruses. The HA-4, 8, and 13 sequences, as predicted, were broadly reactive and consistently exhibited medium to strong signals with nearly all influenza B samples. Other capture sequences, e.g. HA-11 and HA-12, were occasionally detected with varying intensities. In one example, lineage discrimination by pattern recognition was determined by visual observation of different patterns. Alternatively, in another example a quantitative approach was developed in order to avoid user subjectivity. An artificial neural network (ANN) was trained and evaluated for lineage discrimination using on the HA portion of the microarray.

Of 62 exemplary influenza B viruses used in this exemplary study, several were excluded from the neural network analysis. For example, 7 influenza B viruses that were collected years before the lineage split occurred were not included in this study. In addition, 5 influenza B viruses that resulted in a S/N value less than 10 for HA sequences were not considered for lineage assignment. Thus, 50 influenza B viruses were used in combination with the ANN. As there was no preexisting dataset to be used to train the ANN, half of the current dataset was used for training and the other half for querying and vice versa.

FIG. 3A-3C represents discrimination between the two major influenza B virus lineages, Yam88 and Vic87, using the HA section of the BChip. (A) Microarray layout of the HA section; (B) sample B/Johannesburg/5/99 (Yam88-like); (C) sample B/South Carolina/4/2003 (Vic87-like). For the fluorescence images, darker shades represent higher fluorescence.

Normalized relative signal intensities were used as input values in order to eliminate slide-to-slide variations in absolute fluorescence intensity. Output values ranged between 0 and 1, corresponding to false and true, respectively, for the two distinct categories (e.g.Yam88 and Vic87). An output neuron was considered to be fully activated at values at or above 0.9 when using a logistic function, and therefore an output value of 0.9 was used as the cutoff for positive assignments.

The ANN output values are summarized in Table 1. Of all examples (50 influenza B viruses) entered into the ANN, 94% were identified correctly as Yam88-like or Vic87-like viruses, and only 3 cases resulted in no assignment. Interestingly, the only samples in which the ANN failed to yield a correct assignment were Vic87-like viruses. In the present case, the entire dataset consisted of 43 Yam88-like and only 19 Vic87-like examples; thus, the ANN may not have been sufficiently trained for Vic87-like viruses. Although the virus samples originating from years before the lineage split were not considered for lineage determination through ANN analysis, they did exhibit a distinct Yam88-like pattern in the HA region. Further exploration of the precursor viruses may be useful in understanding how influenza B evolved overtime and how lineage differentiation occurred.

Exemplary Table 2 represents capture/label pairs and conserved regions of the HA gene. Exemplary Tables 3 and 4 represent capture/label pairs and conserved regions of the NA gene segments and M gene segments, respectively.

TABLE 2
BChip - capture/label pairs and conserved regions

| | | | | | | |
|---|---|---|---|---|---|---|
| BChip # | name | capture seq (5′) | label seq (3′) | start | end | length |

HA gene segment

| | | | | | | |
|---|---|---|---|---|---|---|
| HA-1 | B-HA-1553 | ACCAGACCTGCTTAGACAGGATAGC | GCTGGCACCTTTAATGCAGGAGAAT | 1553 | 1603 | 51 |
| | | SEQ ID NO. 6 | SEQ ID NO. 7 | | | |
| HA-2 | B-HA-1342 | AACGAAATACTCGAGCTGGATGAGA | AGTGGATGATCTCAGAGCTGACAC | 1342 | 1391 | 50 |
| | | SEQ ID NO. 8 | SEQ ID NO. 9 | | | |
| HA-3 | B-HA-714 | GTTCACCTCATCTGCT | ATGGAGTAACCACACA | 714 | 746 | 33 |
| | | SEQ ID NO. 10 | SEQ ID NO. 11 | | | |
| HA-4 | B-HA-1653 | TGATGATGGATTGGATAACCATACT | TACTGCTCTACTACTCAACTGCTGC | 1653 | 1703 | 51 |
| | | SEQ ID NO. 12 | SEQ ID NO. 13 | | | |
| HA-5 | B-HA-674 | CCCAAATGAAAAACCT | TATGGAGACTCAAATC | 674 | 706 | 33 |
| | | SEQ ID NO. 14 | SEQ ID NO. 15 | | | |
| HA-6 | B-HA-852 | AGGAACAATTACCTATCAAAGAGGT | TTTTATTGCCTCAAAAAGTGTGGTG | 852 | 902 | 51 |
| | | SEQ ID NO. 16 | SEQ ID NO. 17 | | | |
| HA-7 | B-HA-557 | TCCCAAAAAACGACAA | AACAAAACAGCAACAA | 557 | 589 | 33 |
| | | SEQ ID NO. 18 | SEQ ID NO. 19 | | | |
| HA-8 | B-HA-979 | GGTGGATTAAACAAAAGCAAGCC | TACTACACAGGGGAACATGCAAA | 979 | 1025 | 47 |
| | | SEQ ID NO. 20 | SEQ ID NO. 21 | | | |
| HA-9 | B-HA-405 | TCTTCTCAGAGGATACGA | CGTATCAGGTTATCAAA | 405 | 440 | 36 |
| | | SEQ ID NO. 22 | SEQ ID NO. 23 | | | |
| HA-10 | B-HA-313 | GCAAAAGTTTCAATAC | CCATGAAGTAAGACCT | 313 | 345 | 33 |
| | | SEQ ID NO. 24 | SEQ ID NO. 25 | | | |
| HA-11 | B-HA-1027 | GCCATAGGAAATTGCCC | ATATGGGTGAAAACACC | 1027 | 1061 | 35 |
| | | SEQ ID NO. 26 | SEQ ID NO. 27 | | | |
| HA-12 | B-HA-944 | TAATTGGTGAAGCAGAT | GCCTTCATGAAAAATA | 944 | 977 | 34 |
| | | SEQ ID NO. 28 | SEQ ID NO. 29 | | | |
| HA-13 | B-HA-1484 | TAAAGAAAATGCTGGGTCCCTCTGC | GTAGACATAGGGAATGGATGCTTCG | 1484 | 1534 | 51 |
| | | SEQ ID NO. 30 | SEQ ID NO. 31 | | | |

| | | | | |
|---|---|---|---|---|
| BChip # | Conserved region | start | end | length |

| | | | | |
|---|---|---|---|---|
| HA-1 | CGAAACCAAACACAAGTGCAACCAGACCTGCTTAGACAGGATAGCTGCTGGCACCTTTAAT | 1533 | 1623 | 91 |
| | GCAGGAGAATTTTCTCTTCCCACTTTTGAT | | | |
| | SEQ ID NO. 32 | | | |
| HA-2 | GTGCCATGGATGAACTCCATAACGAAATACTCGAGCTGGATGAGAAAGTGGATGATCTCAG | 1322 | 1400 | 79 |
| | AGCTGACACAATAAGCTC | | | |
| | SEQ ID NO. 33 | | | |
| HA-3 | GGAGACTCAAATCCTCAAAAGTTCACCTCATCTGCTAATGGAGTAACCACACATTATGTTT | 694 | 765 | 72 |
| | CTCAGATTGGC | | | |
| | SEQ ID NO. 34 | | | |
| HA-4 | ATTACTGCTGCATCTTTAAATGATGATGGATTGGATAACCATACTATACTGCTCTACTACT | 1633 | 1723 | 91 |
| | CAACTGCTGCTTCTAGTTTGGCTGTAACAT | | | |
| | SEQ ID NO. 35 | | | |
| HA-5 | GTTCCATTCTGATAACAAAACCCAAATGAAAAACCTCTATGGAGACTCAAATCCTCAAAAG | 654 | 722 | 69 |
| | TTCACCTC | | | |
| | SEQ ID NO. 36 | | | |
| HA-6 | GTGCAAAAATCTGGGAAAACAGGAACAATTACCTATCAAAGAGGTATTTTATTGCCTCAAA | 832 | 922 | 91 |
| | AAGTGTGGTGCGCAAGTGGCAGGAGCAAGG | | | |
| | SEQ ID NO. 37 | | | |
| HA-7 | CGCAACAATGGCTTGGGCCGTCCCAAAAAACGACAACAACAAAACAGCAACAAATTCATTA | 537 | 609 | 73 |
| | ACAATAGAAGTA | | | |
| | SEQ ID NO. 38 | | | |
| HA-8 | ATTGCCTCCACGAAAAATACGGTGGATTAAACAAAAGCAAGCCTTACTACACAGGGGAACA | 959 | 1045 | 87 |
| | TGCAAAGGCCATAGGAAATTGCCCAA | | | |
| | SEQ ID NO. 39 | | | |
| HA-9 | AAAATTAGACAGCTGCCCAATCTTCTCAGAGGATACGAACGTATCAGGTTATCAAACCATA | 385 | 460 | 76 |
| | ACGTTATCAATGCAG | | | |
| | SEQ ID NO. 40 | | | |
| HA-10 | GGGAACATACCTTCGGCAAAAGTTTCAATACTCCATGAAGTAAGACCTGTTACATCTGGGT | 298 | 365 | 68 |
| | GCTTTCC | | | |
| | SEQ ID NO. 41 | | | |
| HA-11 | GAACATGCAAAAGCCATAGGAAATTGCCCAATATGGGTGAAAACACCTTTGAAGCTTGCCA | 1015 | 1081 | 67 |
| | ATGGAA | | | |
| | SEQ ID NO. 42 | | | |
| HA-12 | AATAAAAGGGTCCTTGCCTTTAATTGGTGAAGCAGATTGCCTTCATGAAAAATACGGTGGA | 924 | 997 | 74 |
| | TTAAACAAAAGCA | | | |
| | SEQ ID NO. 43 | | | |
| HA-13 | ATTGGCACTTGAGAGAAAACTAAAGAAAATGCTGGGTCCCTCTGCTGTAGACATAGGGAAT | 1464 | 1554 | 91 |
| | GGATGCTTCGAAACCAAACACAAGTGCAAC | | | |
| | SEQ ID NO. 44 | | | |

TABLE 3
NA gene segment

| | | | | | | |
|---|---|---|---|---|---|---|
| BChip # | name | capture seq (5′) | label seq (3′) | start | end | length |

| | | | | | | |
|---|---|---|---|---|---|---|
| NA-1 | B-NA-667 | AATATGGAGAAGCATA | ACTGACACATACCATT | 667 | 699 | 33 |
| | | SEQ ID NO. 45 | SEQ ID NO. 46 | | | |
| NA-2 | B-NA-997 | GATTGATGTGCACAGAGACTTATT | GGACACCCCCAGACCAAATGATG | 997 | 1044 | 48 |
| | | SEQ ID NO. 47 | SEQ ID NO. 48 | | | |
| NA-3 | B-NA-134 | ACTGTCATACTTACTA | ATTCGGATATATTGCT | 134 | 166 | 33 |
| | | SEQ ID NO. 49 | SEQ ID NO. 50 | | | |
| NA-4 | B-NA-496 | GAGACAGAAACAAGCT | AGGCATCTAATTTCAG | 496 | 528 | 33 |
| | | SEQ ID NO. 51 | SEQ ID NO. 52 | | | |
| NA-1 | B-NA-612 | GAATGGACATATATCGGA | TTGATGGCCCTGACAAT | 612 | 647 | 36 |
| | | SEQ ID NO. 53 | SEQ ID NO. 54 | | | |
| NA-6 | B-NA-151 | ATTCGGATATATTGCT | AAATTTTCACCAACAG | 151 | 183 | 33 |
| | | SEQ ID NO. 55 | SEQ ID NO. 56 | | | |
| NA-7 | B-NA-1269 | CCTGGTTGGTATTCTTT | GGTTTCGAAATAAAAG | 1269 | 1302 | 34 |
| | | SEQ ID NO. 57 | SEQ ID NO. 58 | | | |
| NA-8 | B-NA-536 | AGGCAAAATCCCAACTGTAG | AAACTCCATTTTCCACATG | 536 | 575 | 40 |
| | | SEQ ID NO. 59 | SEQ ID NO. 60 | | | |
| NA-9 | B-NA-1136 | TGGAAGATGGTACTCC | GAACGATGTCTAAAAC | 1136 | 1168 | 33 |
| | | SEQ ID NO. 61 | SEQ ID NO. 62 | | | |
| NA-10 | B-NA-234 | CAGGCTGTGAACCGTTCTGCA | CAAAAGGGGTGACACTTCTT | 234 | 275 | 42 |
| | | SEQ ID NO. 63 | SEQ ID NO. 64 | | | |
| NA-11 | B-NA-1362 | ACTTGGCACTCAGCAGC | ACAGCCATTTACTGTTT | 1362 | 1396 | 35 |
| | | SEQ ID NO. 6S | SEQ ID NO. 66 | | | |
| NA-12 | B-NA-776 | TGATGGCTCAGCTTCAGGG | TTAGTGAATGCAGATTTCT | 776 814 | 39 | |
| | | SEQ ID NO. 67 | SEQ ID NO. 68 | | | |
| NA-13 | B-NA-186 | ATAATTGCACCAACAACG | CGTTGGACTCCGCGAAC | 186 | 221 | 36 |
| | | SEQ ID NO. 69 | SEQ ID NO. 70 | | | |
| NA-14 | B-NA-1049 | CATAACAGGGCCTTGCGAATCTA | TGGGGACAAAGGGCGTGGAGGC | 1049 | 1094 | 46 |
| | | SEQ ID NO. 71 | SEQ ID NO. 72 | | | |

| | | | | |
|---|---|---|---|---|
| BChip # | Conserved region | start | end | length |

| | | | | |
|---|---|---|---|---|
| NA-1 | TGCTCAAAATAAAATATGGAGAAGCATATACTGACACATACCATTCCTATGCAAACAAC | 655 | 719 | 65 |
| | ATCCTA | | | |
| | SEQ ID NO. 73 | | | |
| NA-2 | GACTGATACAGCGGAAATAAGATTGATGTGCACAGAGACTTATTTGGACACCCCCAGAC | 977 | 1064 | 88 |
| | CAAATGATGGAAGCATAACAGGGCCTTGC | | | |
| | SEQ ID NO. 74 | | | |
| NA-3 | TCACTATATGTGTCAGCTTCACTGTCATACTTACTATATTCGGATATATTGCTAAAATT | 114 | 177 | 64 |
| | TTCAC | | | |
| | SEQ ID NO. 75 | | | |
| NA-4 | ATACTACAATGGAACAAGAGGAGACAGAAACAAGCTGAGGCATCTAATTTCAGTCAAAT | 476 | 548 | 73 |
| | TGGGCAAAATCCCA | | | |
| | SEQ ID NO. 76 | | | |
| NA-5 | CCGCATGCCATGATGGTAAGGAATGGACATATATCGGAGTTGATGGCCCTGACAATAAT | 592 | 667 | 76 |
| | GCATTGCTCAAAATAAA | | | |
| | SEQ ID NO. 77 | | | |
| NA-6 | ACTGTCATACTTACTATATTCGGATATATTGCTAAAATTTTCACCAACAGAAATAACTG | 134 | 203 | 70 |
| | CACCAACAATG | | | |
| | SEQ ID NO. 78 | | | |
| NA-7 | GAACCTGGTTGGTATTCTTTCGGTTTCGAAATAAAAGATAAGAAATGCGATGTCCCC | 1266 | 1322 | 57 |
| | SEQ ID NO. 79 | | | |
| NA-8 | CAACTTAGGCAAAATCCCAACTGTAGAAAACTCCATTTTCCACATGGCAGCTTGGAG | 530 | 595 | 66 |
| | TGGATCCGC | | | |
| | SEQ ID NO. 80 | | | |
| NA-9 | CAAAGAATGGCATCCAAGATTGGAAGATGGTACTCCCGAACGATGTCTAAAACTGAA | 1116 | 1188 | 73 |
| | AGAATGGGGATGGAAC | | | |
| | SEQ ID NO. 81 | | | |
| NA-10 | GTGCAAACGCATCAAATGTTCAGGCTGTGAACCGTTCTGCAACAAAAGGGGTGACAC | 214 | 295 | 82 |
| | TTCTTCTCCCAGAACCGGAGTGGAC | | | |
| | SEQ ID NO. 82 | | | |
| NA-11 | ACTTGGCACTCAGCAGCAACAGCCATTTACTGTTTAATGGGCTCAGGACAA | 1362 | 1412 | 51 |
| | SEQ ID NO. 83 | | | |
| NA-12 | GATTGTTATCTTATGATAACTGATGGCTCAGCTTCAGGGATTAGTGAATGC | 756 | 834 | 79 |
| | AGATTTCTTAAGATTCGAGAGGGCCGAA | | | |
| | SEQ ID NO. 84 | | | |
| NA-13 | TAAAATTTTCACCAACAAAAATAATTGCACCAACAACGTCGTTGGACTCCG | 166 | 241 | 76 |
| | CGAACGCATCAAATTTTCAGGCCGT | | | |
| | SEQ ID NO. 85 | | | |
| NA-14 | CCCAGACCAGATGATGGAAGCATAACAGGGCCTTGCGAATCTAATGGGGAC | 1029 | 1114 | 86 |
| | AAAGGGCGTGGAGGCATCAAGGGAGGATTT | | | |
| | GTTCA SEQ ID NO. 86 | | | |

TABLE 4
M gene segment

| | | | | | | |
|---|---|---|---|---|---|---|
| BChip # | name | capture seq (5′) | label seq (3′) | start | end | length |

| | | | | | | |
|---|---|---|---|---|---|---|
| M-1 | B-MP-352 | CATGAAGCATTTGAAATAG | AGAAGGCCATGAAAGCTC | 352 | 389 | 38 |
| | | SEQ ID NO. 87 | SEQ ID NO. 88 | | | |
| M-2 | B-M-1002 | ATGGAGATATTGAGTGACC | CATAGTGATTGAGGGGCT | 1002 | 1039 | 38 |
| | | SEQ ID NO. 89 | SEQ ID NO. 90 | | | |
| M-3 | B-M-884 | AATACGAATAAAAGGTCCAA | TAAAGAGACAATAAACAGAG | 884 | 924 | 41 |
| | | SEQ ID NO. 91 | SEQ ID NO. 92 | | | |
| M-4 | B-M-1066 | GTGAAACAGTTTTGGA | GTAGAAGAATTGCATT | 1066 | 1098 | 33 |
| | | SEQ ID NO. 93 | SEQ ID NO. 94 | | | |
| M-5 | B-M-220 | TTTTTAAAACCCAAAGACC | GGAAAGGAAAAGAAGATTC | 2202 | 58 | 39 |
| | | SEQ ID NO. 95 | SEQ ID NO. 96 | | | |
| M-6 | B-M-938 | GAGACACAGTTACCAAAAAGAAATC | AGGCCAAAGAAACAATGAAGGAGGT | 938 | 988 | 51 |
| | | SEQ ID NO. 97 | SEQ ID NO. 98 | | | |
| M-7 | B-M-572 | TGAACACAGCAAAAACAATGAATG | AATGGGGAAGGGAGAAGACGTCC | 572 | 619 | 48 |
| | | SEQ ID NO. 99 | SEQ ID NO. 100 | | | |
| M-8 | B-M-645 | CAACATTGGAGTGCTGAGATCTC | TGGGGCAAGTCAAAAGAATGGGG | 645 | 691 | 47 |
| | | SEQ ID NO. 101 | SEQ ID NO. 102 | | | |
| M-9 | B-M-110 | ACTGTTGGTTCGGTGGGAAAG | ATTTGACCTAGACTCTGCCTT | 110 | 152 | 43 |
| | | SEQ ID NO. 103 | SEQ ID NO. 104 | | | |

| | | | | |
|---|---|---|---|---|
| BChip # | Conserved region | start | end | length |

| | | | | |
|---|---|---|---|---|
| M-1 | AGCTTTCATGAAGCATTTGAAATAGCAGAAGGCCATGAAAGCTCAGCGCTA | 346 | 396 | 51 |
| | SEQ ID NO. 105 | | | |
| M-2 | ACTATCTAACAACATGGAGATATTGAGTGACCACATAGTGATTGAGGGGCTTTCTGCTGA | 989 | 1059 | 71 |
| | AGAGATAATAA | | | |
| | SEQ ID NO. 106 | | | |
| M-3 | AAAAGAGGAGTAAACATGAAAATACGAATAAAAGGTCCAAATAAAGAGACAATAAACAGA | 864 | 944 | 81 |
| | GAGGTATCAATTTTGAGACAC | | | |
| | SEQ ID NO. 107 | | | |
| M-4 | TGAAGAGATAATAAAAATGGGTGAAACAGTTTTGGAGGTAGAAGAATTGCATT | 1046 | 1098 | 53 |
| | SEQ ID NO. 108 | | | |
| M-5 | TAATTGGTGCCTCTATATGCTTTTTAAAACCCAAAGACCAGGAAAGGAAAAGAAGATTCA | 200 | 278 | 79 |
| | TCACAGAGCCTCTATCAGG | | | |
| | SEQ ID NO. 109 | | | |
| M-6 | AACAGAGAGGTATCAATTTTGAGACACAGTTACCAAAAAGAAATCCAGGCCAAAGAAACA | 918 | 1008 | 91 |
| | ATGAAGGAGGTACTCTCTGACAACATGGAGG | | | |
| | SEQ ID NO. 110 | | | |
| M-7 | AATGCAGATGGTTTCAGCTATGAACACAGCAAAAACAATGAATGGAATGGGGAAGGGAGA | 552 | 639 | 88 |
| | AGACGTCCAAAAACTGGCAGAAGAGCTG | | | |
| | SEQ ID NO. 111 | | | |
| M-8 | CTGGCAGAAGAGCTGCAAAGCAACATTGGAGTGCTGAGATCTCTTGGGGCAAGTCAAAAG | 625 | 711 | 87 |
| | AATGGGGAAGGAATTGCAAAGGATGTA | | | |
| | SEQ ID NO. 112 | | | |
| M-9 | AGAACTAGCAGAAAAATTACACTGTTGGTTCGGTGGGAAAGAATTTGACCTAGACTCTGC | 90 | 172 | 83 |
| | CTTGGAATGGATAAAAAACAAAA | | | |
| | SEQ ID NO. 113 | | | |

All of the COMPOSITIONS, METHODS and APPARATI disclosed and claimed herein can be made and executed without undue experimentation in light of the present disclosure. While the compositions, methods and apparatus have been described in terms of preferred embodiments, it will be apparent to those of skill in the art that variations may be applied to the COMPOSITIONS, METHODS and APPARATUS and in the steps or in the sequence of steps of the methods described herein without departing from the concept, spirit and scope of the invention. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. An array comprising:
a plurality of capture probes comprising nucleic acid sequences bound to the surface of a solid substrate, wherein the capture probes are capable of binding to nucleic acid sequences comprising at least a portion of a nucleic acid sequence or complimentary nucleic acid sequence of a target gene of one or more strains of influenza type B.

2. The array of claim 1, further comprising a positive control probe bound to the surface of the solid substrate, wherein the positive control probe is capable of indicating conditions sufficient to form a complex of a capture probe binding to nucleic acid sequences comprising at least a portion of a nucleic acid sequence or complimentary nucleic acid sequence of a target gene.

3. The array of claim 1, wherein the array is a microarray.

4. The array of claim 3, wherein the microarray is a multi-channel microarray.

5. The array of claim 1, wherein the capture probes are capable of binding to one or more nucleic acid sequences comprising at least a portion of a nucleic acid sequence or complimentary nucleic acid sequence of a target gene of one or more influenza B strains chosen from B/Victoria/2/87 (Vic87) strain, B/Victoria/2/87-like strain, B/Yamagata/16/88 (Yam88) strain, B/Yamagata/16/88-like strain and a combination of two or more thereof

6. The array of claim 1, wherein the capture probes are capable of binding to one or more nucleic acid sequences comprising at least a portion of a nucleic acid sequence or complimentary nucleic acid sequence of a target gene of one or more influenza B strains chosen from B/Victoria/2/87 (Vic87) strain, B/Yamagata/16/88 (Yam88) strain, and a combination thereof

7. The array of claim 1, wherein the capture probes are selected from nucleic acid sequences listed in Table 2, Table 3, Table 4 or a combination thereof

8. The array of claim 1, wherein the array contains 100 or less capture probes bound to the surface of the solid substrate.

9. The array of claim 1, wherein the substrate is chosen from glass, plastic, silicon-coated substrate, macromolecule-coated substrate, particles, beads, microparticles, microbeads, dipstick, magnetic beads, paramagnetic beads and a combination of two or more thereof

10. The array of claim 1, wherein the capture probes are about 10 to about 50 nucleotides (nt) in length.

11. A method comprising:
attaching a plurality of capture probes to a solid substrate surface to form an array, wherein the capture probes are capable of binding to nucleic acid sequences comprising at least a portion of a nucleic acid sequence or complimentary nucleic acid sequence of a target gene of one or more strains of influenza type B.

12. The method of claim 11, further comprising attaching a positive control probe to the surface of the solid substrate, wherein the positive control probe is capable of indicating conditions sufficient to form a complex of a capture probe binding to nucleic acid sequences comprising at least a portion of a nucleic acid sequence or complimentary nucleic acid sequence of a target gene.

13. The method of claim 11, wherein the nucleic acid sequences comprise at least a portion of a nucleic acid sequence or complimentary nucleic acid sequence of a target gene selected from the group consisting of hemagglutinin (HA gene segment), neuraminidase (NA gene segment), matrix protein (M gene segment) and a combination of two or more thereof.

14. The method of claim 11, wherein the nucleic acid sequences comprise at least a portion of a nucleic acid sequence of the HA gene.

15. The method of claim 11, wherein said nucleic acid sequences comprise at least a portion of a nucleic acid sequence or complimentary nucleic acid sequence of a target gene of one or more influenza B strains chosen from B/Victoria/2/87 (Vic87) strain, B/Victoria/2/87-like strain, B/Yamagata/16/88 (Yam88) strain, B/Yamagata/16/88-like strain and a combination of two or more thereof.

16. A method for detecting influenza type B strain in a sample, the method comprising:
a) contacting the sample with an array to form a capture probe-sample complex when the sample contains nucleic acid sequences comprising at least a portion of a nucleic acid sequence or complimentary nucleic acid sequence of one or more strains of influenza type B, wherein the array comprises a plurality of capture probes comprising at least a portion of a nucleic acid sequence or complimentary nucleic acid sequence of a target gene of one or more strains of influenza type B; and
b) contacting the capture probe-sample complex with one or more detection probes to produce a labeled array, wherein the labeled array comprises a target-probe complex when a) comprises the capture probe-sample complex, and wherein the presence of the target-probe complex is indicative of the presence of an influenza type B strain.

17. The method of claim 16, wherein the probe comprises one or more tagged label probes and wherein the tagged label probes are capable of producing a signal.

18. The method of claim 16, further comprising contacting the array with a positive control probe, wherein the positive control probe is capable of indicating conditions sufficient to form a complex of a capture probe binding to nucleic acid sequences comprising at least a portion of a nucleic acid sequence or complimentary nucleic acid sequence of a target gene.

19. The method of claim 16, further comprising contacting the array with a negative control probe, wherein the negative control probe is capable of indicating conditions sufficient to indicate specificity of the capture label probes to bind to influenza B virus and not to the negative control probe.

20. The method of claim 16, wherein the influenza B strain is chosen B/Victoria/2/87 (Vic87) strain, B/Victoria/2/87-like strain, B/Yamagata/16/88 (Yam88) strain, B/Yamagata/16/88-like strain and a combination thereof.

21. The method of claim 16, wherein the influenza B strain is chosen from B/Victoria/2/87 (Vic87) strain, B/Yamagata/16/88 (Yam88) strain, and a combination thereof.

22. The method of claim 16, wherein the target gene is chosen from hemagglutinin (HA gene segment), neuraminidase (NA gene segment), matrix protein (M gene segment) and a combination thereof

23. The method of claim 16, wherein the array in c) produces a different signal depending on the influenza type B strain.

24. The method of claim 16, wherein the sample is obtained from a subject.

25. The method of claim 24, wherein the sample is chosen from nasopharangeal washes, expectorate, optical swab, respiratory tract swabs, throat swabs, nasal swabs, nasal mucus, tracheal aspirates, bronchoalveolar lavage, mucus, blood, urine, tissue, saliva and a combination of two or more thereof

26. The method of claim 16, wherein the sample is chosen from air samples, air-filter samples, surface-associated samples and a combination of two or more thereof

27. The method of claim 26, wherein the air samples are derived from a hospital, a temporary or permanent residence, a place of business, a place of education, a daycare, an airplane, a vehicle, a boat or a combination of two or more thereof

28. The method of claim 16, wherein the target gene is the HA gene.

29. The method of claim 16, further comprising identifying an influenza type B strain in 12 hours or less.

30. A kit comprising:
(a) an array of a plurality of capture probes bound to the surface of a solid substrate, wherein the capture probes are capable of binding to nucleic acid sequences comprising at least a portion of a nucleic acid sequence or complimentary nucleic acid sequence of a target gene of one or more strains of influenza type B; and
(b) one or more tagged label probes wherein the tagged label probes are capable of producing a signal and wherein the label probes are capable of binding to the nucleic acid sequences comprising at least a portion of a nucleic acid sequence or complimentary nucleic acid sequence of a target gene of one or more strains of influenza type B.

31. The kit of claim 30, further comprising a positive control probe bound to the surface of the solid substrate, wherein the positive control probe is capable of indicating conditions sufficient to form a complex of a capture probe binding to nucleic acid sequences comprising at least a portion of a nucleic acid sequence or complimentary nucleic acid sequence of a target gene.
